(19) United States
(12) Patent Application Publication
(10) Pub. No.: US 2026/0179158 A1
(43) Pub. Date: Jun. 25, 2026

(54) ARTIFICIAL INTELLIGENCE-BASED SYSTEMS AND METHODS FOR SMART HOME RELATED DATA PREDICTIONS AND RECOMMENDATIONS

(71) Applicant: State Farm Mutual Automobile Insurance Company, Bloomington, IL (US)

(72) Inventors: Alexander Cardona, Gilbert, AZ (US); John Mullins, Santa Monica, CA (US)

(21) Appl. No.: 19/394,385

(22) Filed: Nov. 19, 2025

Related U.S. Application Data
(60) Provisional application No. 63/738,031, filed on Dec. 23, 2024.

(51) Int. Cl. G06Q 50/16; G06N 5/022

(52) U.S. Cl. CPC G06Q 50/16; G06N 5/022

(57) ABSTRACT

A computer system may be programmed to: (1) receive a first home inspection report associated with a first home; (2) extract, using an artificial intelligence model, home data from the first home inspection report, the artificial intelligence model including extraction tools and trained using correlations between historical home inspection reports and historical home data; (3) store the extracted home data for the first home in a data structure including a plurality of data fields; (4) identify at least one data field of the plurality of data fields that is missing a data value; (5) generate, using the artificial intelligence model, at least one predicted data value for the identified at least one data field based upon the historical home data; and/or (6) store the at least one predicted data value in the identified at least one data field.

### CROSS-REFERENCE TO RELATED APPLICATIONS

This application claims the benefit of priority to U.S. Provisional Ser. No. 63/738,031, filed Dec. 23, 2024, and entitled “SYSTEMS AND METHODS FOR GENERATING PREDICTIONS AND RECOMMENDATIONS FOR A HOME USING AN ARTIFICIAL INTELLIGENCE MODEL,” the entire contents and disclosures of which are hereby incorporated herein in their entirety.

### FIELD OF THE DISCLOSURE

The field of the disclosure relates generally to artificial intelligence modeling, and more specifically, to using an artificial intelligence model to extract and augment data from a home inspection report and generate data predictions and recommendations relating to the home based upon the extracted and augmented data.

### BACKGROUND

Large sets of data may not always be easily understandable. For example, a home inspection report may include a large amount of potentially useful data about a home, but may not present the data in a standardized and meaningful format for a human to consume and make decisions. For this reason, a human viewing this data, even if using a computer to view and search through the data, may have difficulty drawing conclusions based upon the data or identifying potential missing data points and/or inaccuracies in the data. Conventional techniques may include additional inefficiencies, encumbrances, ineffectiveness, and/or other drawbacks as well.

### BRIEF DESCRIPTION

The present embodiments may relate to, inter alia, analyzing large amounts of data, parsing that data in order to generate accurate data predictions and recommendations. More specifically, the present computer system may generate accurate predictions and recommendations relating to a home based upon a home inspection report, even in situations where the home inspection report is incomplete or inaccurate.

In particular, the present embodiments include artificial intelligence (AI) based systems and methods that generate data predictions and recommendations for a home or other structure based upon documents including information about the home or other structure, such as a home inspection report. These documents do not need to have a standardized format, and the system may extract data relating to the home or structure (sometimes referred to herein as “home data”) from the documents and store this extracted data in a standardized data format. The system may augment this data using a machine learning and/or artificial intelligence (AI) model, such as a large language trained generative AI model (LLM), that utilizes home data, sometimes referred to as historical home data, relating to similar homes or structures. For example, the system may predict data values that are missing from the home data initially extracted from the document based upon data available from similar homes or structures.

The system may further, using the AI model, generate recommendations (e.g., home maintenance tasks) based upon the home data, which may be presented to a homeowner or other individual responsible for maintaining a home or structure in an easily understandable format such as a list, timeline, and/or calendar. The use of the generative AI model may be available in various mediums such as a computer and/or mobile application, chat screens, notification messages, web pages, voice interaction with a voice chat-capable connected device, voice bots or chat bots, ChatGPT bots, and/or social media messaging. The system may include less, or alternate functionality, including that discussed elsewhere herein.

In one aspect, a computer system for utilizing artificial intelligence tools to extract and augment data from a home inspection report and generate home recommendations may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another, and operate as input and/or output devices. For example, in one instance, the computer system may be programmed to: (1) receive a first home inspection report associated with a first home; (2) extract, using an artificial intelligence model, home data from the first home inspection report, the artificial intelligence model including extraction tools and trained using correlations between historical home inspection reports and historical home data; (3) store the extracted home data for the first home in a data structure including a plurality of data fields; (4) identify at least one data field of the plurality of data fields that is missing a data value; (5) generate, using the artificial intelligence model, at least one predicted data value for the identified at least one data field based upon the historical home data; and/or (6) store the at least one predicted data value in the identified at least one data field. The computer system may include additional, less, or alternate functionality, including that discussed elsewhere herein.

In another aspect, a computing device for utilizing artificial intelligence tools to extract and augment data from a home inspection report and generate home recommendations may be provided. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computing device may include at least one processor programmed to: (1) receive a first home inspection report associated with a first home; (2) extract, using an artificial intelligence model, home data from the first home inspection report, the artificial intelligence model including extraction tools and trained using correlations between historical home inspection reports and historical home data; (3) store the extracted home data for the first home in a data structure including a plurality of data fields; (4) identify at least one data field of the plurality of data fields that is missing a data value; (5) generate, using the artificial intelligence model, at least one predicted data value for the identified at least one data field based upon the historical home data; and/or (6) store the at least one predicted data value in the identified at least one data field. The computing device may include additional, less, or alternate functionality, including that discussed elsewhere herein.

In yet another aspect, a computer-implemented method for utilizing artificial intelligence tools to extract and augment data from a home inspection report and generate home recommendations may be provided. The computer-implemented method may be performed by a computing device including at least one processor and at least one memory device. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another, and operate as input and/or output devices. The method may include, via the at least one processor: (1) receiving a first home inspection report associated with a first home; (2) extracting, using an artificial intelligence model, home data from the first home inspection report, the artificial intelligence model including extraction tools and trained using correlations between historical home inspection reports and historical home data; (3) storing the extracted home data in a data structure including a plurality of data fields; (4) identifying at least one data field of the plurality of data fields that is missing a data value; (5) generating, using the artificial intelligence model, at least one predicted data value for the identified at least one data field based upon the historical home data; and/or (6) storing the at least one predicted data value in the identified at least one data field. The method may have additional, less, or alternate actions, including that discussed elsewhere herein.

In still another aspect, at least one non-transitory computer-readable media having computer-executable instructions embodied thereon for utilizing artificial intelligence tools to extract and augment data from a home inspection report and generate home recommendations may be provided. The computer-executable instructions may be executed by a computing device including one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. When executed by at least one processor, the computer-executable instructions cause the at least one processor to: (1) receive a first home inspection report associated with a first home; (2) extract, using an artificial intelligence model, home data from the first home inspection report, the artificial intelligence model including extraction tools and trained using correlations between historical home inspection reports and historical home data; (3) store the extracted home data for the first home in a data structure including a plurality of data fields; (4) identify at least one data field of the plurality of data fields that is missing a data value; (5) generate, using the artificial intelligence model, at least one predicted data value for the identified at least one data field based upon the historical home data; and/or (6) store the at least one predicted data value in the identified at least one data field. The computer-readable media may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates an exemplary AI-based computer system for utilizing artificial intelligence tools to extract and augment data from a home inspection report and generate home recommendations in accordance with the present disclosure.

FIG. 2 illustrates an expanded home monitoring, analysis, and marketplace system, including the system of FIG. 1, that may be used for utilizing artificial intelligence tools to extract and augment data from a home inspection report and generate home recommendations and evaluating risks associated with a residential house and providing solutions to mitigate those risks.

FIG. 3 illustrates exemplary source devices that may be used with the systems shown in FIGS. 1 and 2 for utilizing artificial intelligence tools to extract and augment data from a home inspection report and generate home recommendations.

FIG. 4 illustrates an exemplary server computing device for use in the systems shown in FIGS. 1 and 2 for training a predictive AI/ML model for utilizing artificial intelligence tools to extract and augment data from a home inspection report and generate home recommendations.

FIG. 5 illustrates an exemplary computer system for utilizing artificial intelligence tools to extract and augment data from a home inspection report and generate home recommendations by implementing the systems shown in FIGS. 1 and 2 performing the computer-implemented method shown in FIGS. 8A-8D.

FIG. 6 depicts an exemplary configuration of a client computer device in accordance with one embodiment of the present disclosure.

FIG. 7 depicts an exemplary configuration of a server computing device in accordance with one embodiment of the present disclosure.

FIG. 8A depicts a flow chart of an exemplary computer-implemented method for utilizing artificial intelligence tools to extract and augment data from a home inspection report and generate home recommendations using the systems shown in FIGS. 1 and 2.

FIG. 8B is a continuation of the flow chart shown in FIG. 8A.

FIG. 8C is a continuation of the flow chart shown in FIGS. 8A and 8B.

FIG. 8D is a continuation of the flow chart shown in FIGS. 8A-8C.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, AI/ML based systems and methods that generate predictions and recommendations for a home or other structure based upon documents including information about the home or other structure, such as home inspection reports. These documents do not need to have a standardized format (and typically do not come in a standardized format, and in many cases include unstructured text in words or sentences and images), and the system may extract data relating to the home or structure (sometimes referred to herein as “home data”) from the documents and store this extracted data in a standardized data format. The system may augment this data using a machine learning (ML) and/or AI model, such as a large language trained generative AI model, that utilizes home data relating to similar homes or structures. For example, the system may predict data values that are missing from the data initially extracted from the document based upon data available from similar homes or structures.

The system may further, using the AI model, generate recommendations (e.g., home maintenance tasks) based upon the home data, which may be presented to a homeowner or other individual responsible for maintaining a home or structure in an easily understandable and meaningful format for a user such as a list, timeline, and/or calendar. The use of the generative AI model may be available in various mediums such as a computer and/or mobile application, chat screens, notification messages, web pages, voice interaction with a voice chat-capable connected device, voice bots or chat bots, ChatGPT bots, and/or social media messaging. In other words, the generative AI model may generate a recommendation for a homeowner to execute at their home, and that recommendation may take the form of a video, VR data or AR data that shows the homeowner how to carry out the recommended task at the home. For example, the recommendation may be a task that includes repairing a water pipe at the home. The video or other data may be sent to the homeowner so that they can see specifically how to repair the pipe within the home of the homeowner.

While the term “home” is used herein, one having skill in the art would understand that the home could be, but is not limited to, a house, an apartment, a townhome, a multi-family home, a condo/co-op, a manufactured home, a mobile home, a business, and/or any other residence, building, or portion of building that may be associated with an inspection report. Similarly, the terms “home data” and “home inspection report” may apply respectively to data and inspection reports relating to any of the aforementioned structures.

In the exemplary embodiment, the system may be configured to train an AI model based upon historical home inspection reports and historical home data. The historical home inspection reports may include labels and/or other features that enable the system to determine whether the historical home inspection reports include or do not include missing data fields, which enables the AI model, once trained, to recognize patterns and correlations that indicate whether subsequently input home inspection reports are missing data fields and identify any missing data fields if present. In some cases, the historical home inspection reports do not necessarily include labels (e.g., indicating whether they are missing data fields), and the system may identify patterns in the historical home inspection reports to determine which data fields are typically included. This information in turn may server as a reference point based on which other home inspection reports can be compared to determine if they are missing any potentially useful data fields.

The historical home data may include data extracted from historical home inspection reports, historical sensor data (e.g., derived from smart home sensors), and/or data derived from external (e.g., third-party) sources. For example, the AI model may leverage a large number of home inspection reports, which may be uploaded to the system in association with individual respective houses, to identify and create a database of common issues or geographically-related patterns or trends shared by regions, communities, neighborhoods, and/or cities. In some embodiments, in addition to the historical home inspection reports, other data may be used, such as sensor data derived from smart home devices and/or data derived from other external data sources as described herein.

By leveraging historical home data and external data sources including historical home data that relates to other similarly situated homes in similar geographic areas, the AI model may be capable of identifying common issues that homeowners should consider. For example, the system may alert a homeowner of an issue missing in their home inspection report that was identified in another home of like kind and quality, or a trend in similar homes based upon region, year built, geographic location, flood data, weather data, claims data, or other data. The AI based system may also be able to customize predictions and recommendations based on the specific types of appliances and other equipment included within the home. For example, a certain brand and model of dishwasher may have different repair issues then other brands. The system described herein is configured to account for those different brands and models when making predictions and recommendations.

In the exemplary embodiment, the system may receive a home inspection report associated with a first home. The home inspection report may be a digital version of the home inspection report or it may be a scanned version that is scanned into the system. For example, a user associated with a home may, through a user device, access an application (e.g., a mobile app, chat screen, notification message, web page, voice interaction with a voice chat-capable connected home device) through which a home inspection report may be uploaded to the system. The user device may be, for example, a personal computer, mobile device (e.g., a smart phone), tablet, and/or another type of computing device. The system may cause the user device to display a prompt to upload, capture an image of, or otherwise input a home inspection report.

For example, if the home inspection report exists in paper or other non-digital format, the user can use their printer/scanner to scan in the pages to a digital PDF file, and then upload the PDF file via the application, or can use their user device, if camera-equipped, to capture photos of each page of the home inspection report. In these cases, the application may provide prompts and instructions during the image capture process to ensure that the images are legible to the system. For example, if the system determines an image is too dark to be processed, the system may cause the application to prompt the user to recapture the image in good lighting. If the image is legible, the system may cause the application to prompt the user to capture a next page of the home inspection report until the entire home inspection report has been captured. If the report is available in a digital format, the application may enable the user to upload and add the file, which may then be transferred to the system.

In the exemplary embodiment, the system may be configured to extract, using the AI model, home data from the home inspection report and store the extracted home data for the first home in a predefined data structure including a plurality of predefined data fields. For example, the system may utilize optical character recognition (OCR) techniques to extract text, handwriting and structure data from scanned documents or images. From this extracted information, the AI model may generate home data by identifying data values and data types associated with these data values, which may correspond to the predefined data fields. The system can then use this data to generate a database (e.g., having the predefined data structure) that is associated with the individual home as well as incorporating the home data into a larger database for all homes and reports in the platform. Unlike the input home inspection reports, which are static, the home data stored in the database may be dynamically updated, as described in further detail below.

In some embodiments, in addition to using the AI model to read and process the input home inspection report documents, the system may use the AI model to generate digital sections or categories that correspond to the different sections that commonly appear in home inspection reports. These digital sections may each be associated with one or more of the predefined data fields, and may include, for example: (1) property information (e.g., address, date of inspection, client); (2) summary or overview (e.g., a high level summary of findings, highlighting significant issues or areas that require attention); (3) roof (e.g., condition, materials used, flashing, gutters, observed damage); (4) exterior; (5) structure; (6) plumbing; (7) electrical; (8) heating, ventilation, and air conditioning (HVAC); (9) interior; (10) insulation and ventilation; and/or (11) miscellaneous or other. These digital sections may increase human understandability of the home data and be used as an input in further processing of the data by the AI model as described elsewhere herein.

In the exemplary embodiment, the system may be further configured to identify one or more data fields of the plurality of predefined data fields that is missing a data value and generate, using the AI model, at least one predicted data value for the identified data fields based upon historical home data. For example, if a homeowner is purchasing home A and the platform has existing data on home B and home C that are in the same neighborhood and were built around the same time, then the system may identify missing data values in home A's inspection report that were identified in home B and C's inspection reports and generate predicted values.

For example, if homes B and C had to replace their roofs recently due to the roofs having reached their life expectancy, and no information about the roof of home A is identified in home A's inspection report, the system may alert the user that this data is missing, predict an age of the roof of home A, and/or generate a recommendation to have the roof inspected. In some embodiments, for example, the system may be configured to prompt a user to take and submit pictures of the roof of home A to further use AI tools to determine whether the roof for home A needs to be replaced immediately, soon or has already been replaced. In other embodiments, the system may be configured to cause a drone to be deployed to capture images of the roof of home A and submit those pictures to an AI model to evaluate them and determine whether the roof of home A needs to be replaced immediately, soon, or has already been replaced.

In another example, if homes B and C recently had to replace their HVAC systems, and no information is available about the HVAC system of home A is identified in home A's inspection report, the system may alert the user that this data is missing, predict an age or condition of the HVAC system of home A, and/or generate a recommendation to have the HVAC system inspected further. In some embodiments, the system may retrieve sensor data from the home to determine a condition of the HVAC system. For example, the system may utilize temperature data received from a smart thermostat to determine whether the temperature of the home is being maintained within a target or demanded range, and/or retrieve electrical data to determine if the HVAC system is drawing an appropriate amount of power or an amount of power that indicates the HVAC system may not be functioning properly. In some cases, external data, such as data relating to the climate and/or weather conditions around the home may be used to determine whether the heating and cooling demands on the HVAC system are normal or above normal. Based upon this data, the AI model may determine whether the HVAC system needs to be replaced immediately, soon, or has already been replaced.

In another example, if homes B and C recently had work done on their respective plumbing systems, and no information is available about the plumbing system of home A is identified in home A's inspection report, the system may alert the user that this data is missing, predict a condition of the plumbing system of home A, and/or generate a recommendation to have the plumbing system inspected further. In some embodiments, the system may retrieve sensor data from the home to determine a condition of the plumbing. For example, the system may utilize data from moisture sensors of the home and/or water usage data from smart water meters and/or smart appliances (e.g., washing machines, dishwashers, refrigerators) to determine if leaks are occurring, and/or may utilize aerial photography and/or deploy a drone to determine if any plants are present with roots that may cause damage to lateral pipes. Based upon this data, the AI model may determine whether any plumbing needs to be replaced immediately, soon, or has already been replaced.

The system may store any predicted data values in their corresponding data fields. In certain embodiments, the system may cause the user device associated with the home to display at least some of the home data associated with the home including predicted data values.

In certain embodiments, the system may receive sensor data from, for example, a sensor, a smart device, or a home controller disposed in the home, or from an external data source, and may generate predicted data values further based upon the sensor data. For example, if the home data extracted from the home inspection report does not include data values relating to certain aspects of the home's electrical system, and the home has an electricity monitoring system in communication with the system, the system may identify sensor data from the electricity monitoring system that can be used to populate empty data fields within the database and/or may generate home data that can be stored in the database by using this sensor data as an input to the AI model. Various data sources that can be used to augment the home data in this manner are described in further detail below. In other words, the system described herein can determine if there is sensor data that can be collected to further complete the home data table, and if so, the system can retrieve that data from the home controller or smart item and then augment the home data with the collected sensor data.

In some such embodiments, the system may utilize sensor data and/or external data to verify the accuracy of home data extracted from the input home inspection report. The system may identify one or more inaccurate data values from the extracted home data based upon the received sensor data and generate, using the AI model, an updated data value to replace the inaccurate data values based upon the sensor data. For example, the input home inspection report may indicate that there are no issues with the home's electrical system, but sensor data received from an electricity monitoring system of the home may indicate that some electrical issue likely exists.

The system may, using the AI model, identify such conflicts between the home data extracted from the input home inspection report and sensor data and/or external data and determine whether the home data should be updated. For example, the AI model may identify cases where sensor data may be considered more accurate than data originating from a home inspection report (e.g., issues that may not easily be observed by a home inspector), and may update the home data stored in the database if there is conflicting data relating to one of these cases. The system may also flag these inconsistencies and recommend steps to be taken to address them.

In the exemplary embodiment, the system may further generate, using the AI model, one or more recommended tasks based upon the home data and to cause the user device associated with the home to display the recommended tasks (e.g., home maintenance tasks, scheduling further inspections, etc.). The home data may include data extracted directly from the home inspection report, data values, or other data sources (e.g., sensor data). In cases in which a plurality of recommended tasks are generated, the system may determine, using the AI model, a priority for each of the plurality of recommended tasks based, for example, on goals of a homeowner, potential risk, future issues if left untreated, and may cause the user device to display the plurality of recommended tasks in an order based upon the determined priority. The system may determine this priority by parsing the home data to identify any high priority items (e.g., items identified per the inspector's recommendations) and identifying items that if not rectified quickly could lead to extensive property damage (e.g., watermarks on interior ceilings indicating a leaky roof) or injuries (e.g., missing handrails/railings). By leveraging the AI model and historical home data, these items can be tagged based upon difficulty, time, cost or other factors.

For example, the system may generate a to-do list, timeline, or calendar to be displayed through the application based upon importance, cost, time, seasonality of different recommended tasks and set reminders and notifications to address those items. The user may interact with the application to accept platform generated recommendations, reject others (e.g., removing from the list), add in their own, and/or share them with other users. Each recommended task may include detailed descriptions, observations, photographs and recommendations for repairs or further evaluations by specialized professionals. The recommendations may further include video instructions on how to perform the repair task specific to the home, or may include VR or AR data to further instruct the homeowner on how to perform the specific task on the item within the home. The recommended tasks may also be added to a calendar application of the user device or otherwise shared with other devices to provide future reminders for the user to be better able to stay on top of upcoming recommended tasks.

In some embodiments, the system is configured to generate, using the AI model, digital instructional content based upon the at least one recommended task and cause the user device to present the generated digital instructional content so that a user is able to perform the repair task on the item associated with the first home. For example, the system may utilize the AI model and/or chatbots to deliver information such as step-by-step instructions, reasons to correct an identified condition in the house, and create prompts with written content, illustrations, audio, and video. In certain embodiments, the system may utilize AI-generated images to show an ideal state versus a problematic state and/or compare with photos from inspection. For example, a photo taken during the inspection showing a condition in a portion of the home may be shown side-by-side with an AI-generated photo showing the same portion of the home with the condition fixed, or an augmented reality (AR) or virtual reality (VR) overlay may be displayed over a live photo stream including the portion of the home.

In certain embodiments, the system may further be configured to enable purchasing goods or services relating to the generated recommended tasks through the application. Some of these recommended tasks may require the expertise of a specialized professional (e.g., a licensed/insured/bonded plumber or electrician). To simplify completion of the recommended tasks, the system may be configured to identify local licensed and insured contractors within a predefined geographic area of the home and cause the mobile application to display the identified contractors along with other relevant information for each contractor such as corresponding reviews (and/or dates and times of availability to perform services, such as repair or replacement work). The application may further include an appointment scheduling system that is integrated with a calendar system used by each contractor enabling seamless scheduling of appointments within the application. The system may also track confirmed/completed appointments for historical documentation. For example, the system may update the home data in the database based upon the completion of recommended tasks.

In some embodiments, the AI model may search websites, stores, and/or services relating to the recommended tasks and, in some such embodiments, provide a link (e.g., a hyperlink) to the recommended websites, stores, and/or services to the user via a computing device (e.g., via a mobile application, web page, and/or email). For example, the links may relate to maintenance services or supplies.

In certain embodiments, the system may be programmed to use the AI model to ask the user questions directly about home concerns, for example, via natural language and/or text prompts. The AI model may use geolocation to determine a repair and/or maintenance professional located near, at, or around the vicinity of the user's geolocation, and then recommend that professional for helping with recommended tasks (e.g., as a generated audio response).

In some embodiments, the system may be communicatively coupled to a communication network and/or a financial services provider (e.g., an insurance provider). The system may receive insurance information from the financial services provider. This insurance information may include claims information relating to specific claims submitted in the vicinity or surrounding geolocation of the homeowner. Therefore, the system may be configured to use insurance claims data when training the AI model to better determine when repairs and/or replacement is needed for an item within the home, and how such repairs should be performed on specific items (brands and models) within a home. This can be done using historical claims data. The system may connect an insurance policy of the homeowner to the recommended tasks, in which the application may display potential changes to the homeowner's insurance policy based upon implementation of the recommended tasks. The system may prioritize the recommendations based upon potential changes to a customer's insurance policy or claims information submitted by other customers living in an area geolocated near the homeowner.

In certain embodiments, the system may also be in communication with one or more marketplaces that provide access to and matching with companies and/or individuals that provide products and/or services recommended by the AI model. In some embodiments, homeowners may be able to list items or services on the marketplace for sale and/or transfer to other homeowners.

In some embodiments, the system may include a risk evaluation engine that may evaluate home data (e.g., data extracted from home inspection reports) to evaluate various risks associated with the home. The system may use numerous data points to evaluate such risks to a residential property and may compute a composite risk score and/or various focused risk scores for the property. The risk score (e.g., or likelihood of damage score) may be a numeric value and/or a category (e.g., excellent, good, fair, and poor).

Such risk scores may be used, for example, to prioritize recommended tasks for maintaining the home, to evaluate insurability of the property and its assets, to price insurance policy options for the property, or to provide policy discounts and verify compliance for risk mitigating changes, actions, or behaviors. The system may generate a risk score for different categories of risk, such as property risk, fire protection, and safety, which may be presented individually within the user interface with related recommendations. For example, the fire protection rating may be displayed along with fire-protection related recommendations, such as recommended tasks that may result in a reduction of fire risk if implemented.

While various examples provided herein describe application of the system to various aspects of homes and related home systems, the systems and methods described herein may also be used for performing other analysis, such as vehicles, businesses, municipal locations, and/or other locations and/or items.

While the term home is used herein, one having skill in the art would understand that the home could be, but is not limited to, a house, an apartment, a townhome, a multi-family home, a condo/co-op, a manufactured home, a mobile home, a business, and/or any other residence, building, or portion of building that may be associated with an inspection report.

### Exemplary System for Generating Recommendations

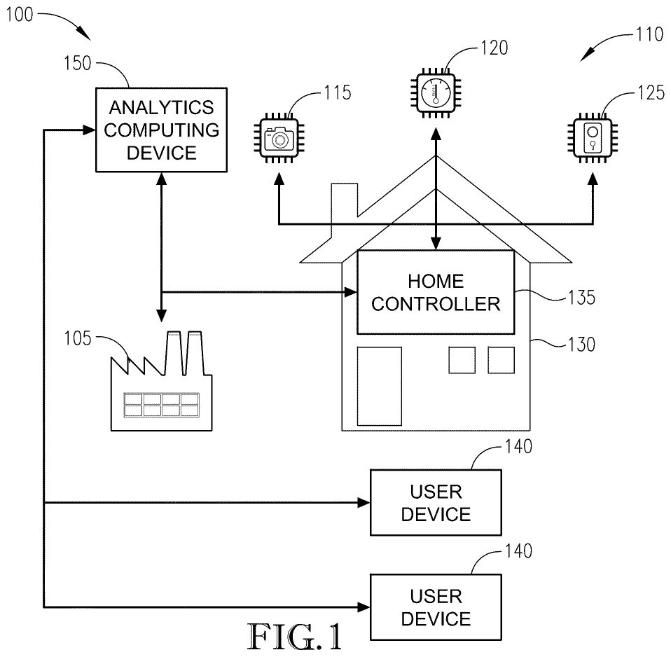

FIG. 1 illustrates an exemplary computer system 100 for generating AI-based recommendations for utilizing artificial intelligence tools to extract and augment data from a home inspection report and generate home recommendations in accordance with at least one embodiment of this disclosure. System 100 illustrates monitoring devices and other sensor devices configured to receive, analyze, and report the data collected about a home 130.

In the exemplary embodiment, the home 130 includes one or more IoT devices 110, also known as Internet connected devices 110. IoT devices 110 may include, but are not limited to IoT cameras 115, IoT thermostats 120, IoT door locks 125, and could also include IoT washers/dryers, IoT stoves/ovens, and/or any other internet connected device, including, but not limited to, home sensors and/or monitoring systems and user devices 140, which may be mobile devices, laptops, appliances, and/or a mobile phones, one or more voice or chat bots, a computer device, including, but not limited to, a desktop computer and/or a router, and/or a home controller 135. In at least one embodiment, the home controller 135 is in wired or wireless communication the one or more IoT devices 110 in the home 130. In some embodiments, the home controller 135 may be a router or Wi-Fi providing device in the home 130. In other embodiments, the home controller 135 is a smart home controller that controls one or more of IoT devices 110 and may provide communication between the user and the individual IoT devices 110. In some embodiments, the user is the homeowner or a representative of the homeowner.

In some embodiments, each IoT device 110 may collect data about the home 130 and items in the home 130 either directly or indirectly. For example, a smart light bulb may report when the bulb is on and off. This may indirectly indicate whether or not an individual is near the bulb. In the at least one embodiment, many IoT devices 110 are in communication with one or more manufacturer servers 105. The manufacturer servers 105 may provide additional services, such as remote activation. The manufacturer server 105 may also collect data observed by IoT device 110, including, but not limited to, usage data about IoT device 110, e.g., hours of operation, number of loads, error codes, etc.

In some embodiments, an analytics computing device 150 may be in communication with one or more of the IoT devices 110, the home controller 135, and/or the manufacturer servers 105. Analytics computing device 150 may be server located remotely from or within home 130 and/or may be implemented utilizing cloud computing resources.

In the exemplary embodiment, analytics computing device 150 may be configured to train an AI model based upon historical home inspection reports and historical home data. The historical home inspection reports may include labels and/or other features that enable analytics computing device 150 to determine whether the historical home inspection reports include or do not include missing data fields, which enables the AI model, once trained, to recognize patterns and correlations that indicate whether subsequently input home inspection reports are missing data fields and identify any missing data fields if present. In some cases, the historical home inspection reports do not necessarily include labels (e.g., indicating whether they are missing data fields), and analytics computing device 150 may identify patterns in the historical home inspection reports to determine which data fields are typically included. This information in turn may serve as a reference point based on which other home inspection reports can be compared to determine if they are missing any potentially useful data fields.

The historical home data may include data extracted from historical home inspection reports, historical sensor data (e.g., derived from IoT devices 110), and/or data derived from external (e.g., third-party) sources. For example, the AI model may leverage a large number of home inspection reports, which may be uploaded to analytics computing device 150 in association with individual respective homes 130, to identify and create a database of common issues or geographically-related patterns or trends shared by regions, communities, neighborhoods, and/or cities. In some embodiments, in addition to the historical home inspection reports, other data may be used, such as sensor data derived from smart home devices and/or data derived from other external data sources as described herein.

By leveraging historical home data and external data sources including historical home data that relates to other similarly situated homes in similar geographic areas, the AI model may be capable of identifying common issues that homeowners should consider. For example, the system may alert a homeowner of an issue missing in their home inspection report that was identified in another home of like kind and quality, or a trend in similar homes 130 based upon region, year built, geographic location, flood data, weather data, claims data, or other data. Analytics computing device 150 may also be able to customize predictions and recommendations based on the specific types of appliances and other equipment included within the home. For example, a certain brand and model of dishwasher may have different repair issues then other brands. The system described herein is configured to account for those different brands and models when making predictions and recommendations.

In the exemplary embodiment, analytics computing device 150 may receive a home inspection report associated with a first home. The home inspection report may be a digital version of the home inspection report or it may be a scanned version that is scanned into the system. For example, a user associated with a home may access, through user device 140 an application (e.g., a mobile app, chat screen, notification message, web page, voice interaction with a voice chat-capable connected home device) through which a home inspection report may be uploaded to the system. Analytics computing device 150 may cause user device 140 to display a prompt to upload, capture an image of, or otherwise input a home inspection report.

For example, if the home inspection report exists in paper or other non-digital format, the user can use their printer/scanner to scan in the pages to a digital PDF file, and then upload the PDF file via the application, or can use their user device 140, if camera-equipped, to capture photos of each page of the home inspection report. In these cases, the application may provide prompts and instructions during the image capture process to ensure that the images are legible to the system. For example, if analytics computing device 150 determines an image is too dark to be processed, analytics computing device 150 may cause the application to prompt the user to recapture the image in good lighting. If the image is legible, analytics computing device 150 may cause the application to prompt the user to capture a next page of the home inspection report until the entire home inspection report has been captured. If the report is available in a digital format, the application may enable the user to upload and add the file, which may then be transferred to analytics computing device 150.

In the exemplary embodiment, analytics computing device 150 may be configured to extract, using the AI model, home data from the home inspection report and store the extracted home data for the first home in a predefined data structure including a plurality of predefined data fields. For example, analytics computing device 150 may utilize OCR techniques to extract text, handwriting and structure data from scanned documents or images. From this extracted information, the AI model may generate home data by identifying data values and data types associated with these data values, which may correspond to the predefined data fields.

Analytics computing device 150 can then use this data to generate a database (e.g., having the predefined data structure) that is associated with the individual home 130 as well as incorporating the home data into a larger database for all homes 130 and reports in the platform. Unlike the input home inspection reports, which are static, the home data stored in the database may be dynamically updated, as described in further detail below.

In some embodiments, in addition to using the AI model to read and process the input home inspection report documents, analytics computing device 150 may use the AI model to generate digital sections or categories that correspond to the different sections that commonly appear in home inspection reports. These digital sections may each be associated with one or more of the predefined data fields, and may include, for example: (1) property information (e.g., address, date of inspection, client); (2) summary or overview (e.g., a high level summary of findings, highlighting significant issues or areas that require attention); (3) roof (e.g., condition, materials used, flashing, gutters, observed damage); (4) exterior; (5) structure; (6) plumbing; (7) electrical; (8) heating, ventilation, and air conditioning (HVAC); (9) interior; (10) insulation and ventilation; and/or (11) miscellaneous or other. These digital sections may increase human understandability of the home data and be used as an input in further processing of the data by the AI model as described elsewhere herein.

In the exemplary embodiment, analytics computing device 150 may be further configured to identify one or more data fields of the plurality of predefined data fields that is missing a data value and generate, using the AI model, at least one predicted data value for the identified data fields based upon historical home data. For example, if a homeowner is purchasing home A and the platform has existing data on home B and home C that are in the same neighborhood and were built around the same time, then analytics computing device 150 may identify missing data values in home A's inspection report that were identified in home B and C's inspection reports and generate predicted values.

For instance, if homes B and C had to replace their roofs recently due to the roofs having reached their life expectancy, and no information about the roof of home A is identified in home A's inspection report, analytics computing device 150 may alert the user that this data is missing, predict an age of the roof of home A, and/or generate a recommendation to have the roof inspected. Analytics computing device 150 may store any predicted data values in their corresponding data fields. In certain embodiments, analytics computing device 150 may cause a user device 140 associated with home 130 to display at least some of the home data associated with home 130 including predicted data values. In some embodiments, for example, analytics computing device 150 may be configured to prompt a user to take and submit pictures of the roof of home A to further use AI tools to determine whether the roof for home A needs to be replaced immediately, soon or has already been replaced. In other embodiments, analytics computing device 150 may be configured to cause a drone to be deployed to capture images of the roof of home A and submit those pictures to an AI model to evaluate them and determine whether the roof of home A needs to be replaced immediately, soon, or has already been replaced.

In another example, if homes B and C recently had to replace their HVAC systems, and no information is available about the HVAC system of home A is identified in home A's inspection report, analytics computing device 150 may alert the user that this data is missing, predict an age or condition of the HVAC system of home A, and/or generate a recommendation to have the HVAC system inspected further. In some embodiments, analytics computing device 150 may retrieve sensor data from home controller 135 to determine a condition of the HVAC system. For example, the system may utilize temperature data received from IoT thermostat 120 to determine whether the temperature of the home is being maintained within a target or demanded range, and/or retrieve electrical data to determine if the HVAC system is drawing an appropriate amount of power or an amount of power that indicates the HVAC system may not be functioning properly. In some cases, external data, such as data relating to the climate and/or weather conditions around the home may be used to determine whether the heating and cooling demands on the HVAC system are normal or above normal. Based upon this data, the AI model may determine whether the HVAC system needs to be replaced immediately, soon, or has already been replaced.

In another example, if homes B and C recently had work done on their respective plumbing systems, and no information is available about the plumbing system of home A is identified in home A's inspection report, analytics computing device 150 may alert the user that this data is missing, predict a condition of the plumbing system of home A, and/or generate a recommendation to have the plumbing system inspected further. In some embodiments, analytic computing device 150 may retrieve sensor data from home controller 135 to determine a condition of the plumbing. For example, the system may utilize data from moisture sensors of the home and/or water usage data from smart water meters and/or IoT devices 110 (e.g., washing machines, dishwashers, refrigerators) to determine if leaks are occurring, and/or may utilize aerial photography and/or deploy a drone to determine if any plants are present with roots that may cause damage to lateral pipes. Based upon this data, the AI model may determine whether any plumbing needs to be replaced immediately, soon, or has already been replaced.

In certain embodiments, analytics computing device 150 may receive sensor data from, for example, IoT devices 110 (e.g., sensors and/or smart devices) and/or home controller 135 disposed in home 130, or from an external data source, and may generate predicted data values further based upon the sensor data. For example, if the home data extracted from the home inspection report does not include data values relating to certain aspects of an electrical system of home 130, and home 130 has an electricity monitoring system in communication with analytics computing device 150, analytics computing device 150 may identify sensor data from the electricity monitoring system that can be used to populate empty data fields within the database and/or may generate home data that can be stored in the database by using this sensor data as an input to the AI model. Various data sources that can be used to augment the home data in this manner are described in further detail below. In other words, analytics computing device 150 determine if there is sensor data that can be collected to further complete the home data table, and if so, analytics computing device 150 can retrieve that data from the home controller or smart item and then augment the home data with the collected sensor data.

In some such embodiments, analytics computing device 150 may utilize sensor data and/or external data to verify the accuracy of home data extracted from the input home inspection report. Analytics computing device 150 may identify one or more inaccurate data values from the extracted home data based upon the received sensor data and generate, using the AI model, an updated data value to replace the inaccurate data values based upon the sensor data. For example, the input home inspection report may indicate that there are no issues with an electrical system of home 130, but sensor data received from an electricity monitoring system of home 130 may indicate that some electrical issue likely exists.

Analytics computing device 150 may, using the AI model, identify such conflicts between the home data extracted from the input home inspection report and sensor data and/or external data and determine whether the home data should be updated. For example, the AI model may identify cases where sensor data may be considered more accurate than data originating from a home inspection report (e.g., issues that may not easily be observed by a home inspector), and may update the home data stored in the database if there is conflicting data relating to one of these cases. Analytics computing device 150 may also flag these inconsistencies and recommend steps to be taken to address them.

In the exemplary embodiment, analytics computing device 150 may further generate, using the AI model, one or more recommended tasks based upon the home data and to cause a user device 140 associated with home 130 to display the recommended tasks (e.g., home maintenance tasks, scheduling further inspections, etc.). The home data may include data extracted directly from the home inspection report, data values, or other data sources (e.g., sensor data).

In cases in which a plurality of recommended tasks are generated, analytics computing device 150 may determine, using the AI model, a priority for each of the plurality of recommended tasks based, for example, on goals of a homeowner, potential risk, future issues if left untreated, and may cause user device 140 to display the plurality of recommended tasks in an order based upon the determined priority. Analytics computing device 150 may determine this priority by parsing the home data to identify any high priority items (e.g., items identified per the inspector's recommendations) and identifying items that if not rectified quickly could lead to extensive property damage (e.g., watermarks on interior ceilings indicating a leaky roof) or injuries (e.g., missing handrails/railings). By leveraging the AI model and historical home data, these items can be tagged based upon difficulty, time, cost or other factors.

For example, analytics computing device 150 may generate a to-do list, timeline, or calendar to be displayed through the application based upon importance, cost, time, seasonality of different recommended tasks and set reminders and notifications to address those items. The user may interact with the application to accept platform generated recommendations, reject others (e.g., removing from the list), add in their own, and/or share them with other users. Each recommended task may include detailed descriptions, observations, photographs and recommendations for repairs or further evaluations by specialized professionals. The recommendations may further include video instructions on how to perform the repair task specific to the home, or may include VR or AR data to further instruct the homeowner on how to perform the specific task on the item within the home. The recommended tasks may also be added to a calendar application of user device 140 or otherwise shared with other devices to provide future reminders for the user to be better able to stay on top of upcoming recommended tasks.

In some embodiments, analytics computing device 150 is configured to generate, using the AI model, digital instructional content based upon the at least one recommended task and cause user device 140 to present the generated digital instructional content so that a user is able to perform the repair task on the item associated with the first home. For example, analytics computing device 150 may utilize the AI model and/or chatbots to deliver information such as step-by-step instructions, reasons to correct an identified condition in the house, and create prompts with written content, illustrations, audio, and video. In certain embodiments, analytics computing device 150 may utilize AI-generated images to show an ideal state versus a problematic state and/or compare with photos from inspection. For example, a photo taken during the inspection showing a condition in a portion of the home may be shown side-by-side with an AI-generated photo showing the same portion of the home with the condition fixed, or an AR or VR overlay may be displayed over a live photo stream including the portion of the home.

In certain embodiments, analytics computing device 150 may further be configured to enable purchasing goods or services relating to the generated recommended tasks through the application. Some of these recommended tasks may require the expertise of a specialized professional (e.g., a licensed/insured/bonded plumber or electrician). To simplify completion of the recommended tasks, analytics computing device 150 may be configured to identify local licensed and insured contractors within a predefined geographic area of home 130 and cause the application to display the identified contractors along with other relevant information for each contractor such as corresponding reviews, and time of availability to perform services, such as repair or replacement work.

The application may further include an appointment scheduling system that is integrated with a calendar system used by each contractor enabling seamless scheduling of appointments within the application. Analytics computing device 150 may also track confirmed/completed appointments for historical documentation. For example, analytics computing device 150 may update the home data in the database based upon the completion of recommended tasks.

In some embodiments, the AI model may search websites, stores, and/or services relating to the recommended tasks and, in some such embodiments, provide a link (e.g., a hyperlink) to the recommended websites, stores, and/or services to the user via user device 140 (e.g., via a mobile application, web page, and/or email). For example, the links may relate to maintenance services or supplies.

In certain embodiments, analytics computing device 150 may be programmed to use the AI model to ask the user questions directly about home concerns, for example, via natural language and/or text prompts. The AI model may use geolocation to determine a repair and/or maintenance professional located near, at, or around the vicinity of the user's geolocation, and then recommend that professional for helping with recommended tasks (e.g., as a generated audio response).

In some embodiments, analytics computing device 150 may be communicatively coupled to a communication network and/or a financial services provider (e.g., an insurance provider). Analytics computing device 150 may receive insurance information from the financial services provider. This insurance information may include claims information relating to specific claims submitted in the vicinity or surrounding geolocation of the homeowner. Therefore, analytics computing device 150 may be configured to use insurance claims data when training the AI model to better determine when repairs and/or replacement is needed for an item within the home, and how such repairs should be performed on specific items (brands and models) within a home. This can be done using historical claims data. Analytics computing device 150 may connect an insurance policy of the homeowner to the recommended tasks, in which the application may display potential changes to the homeowner's insurance policy based upon implementation of the recommended tasks. Analytics computing device 150 may prioritize the recommendations based upon potential changes to a customer's insurance policy or claims information submitted by other customers living in an area geolocated near the homeowner.

In certain embodiments, analytics computing device 150 may also be in communication with one or more marketplaces that provide access to and matching with companies and/or individuals that provide products and/or services recommended by the AI model. In some embodiments, homeowners may be able to list items or services on the marketplace for sale and/or transfer to other homeowners.

In some embodiments, analytics computing device 150 may include a risk evaluation engine that may evaluate home data (e.g., data extracted from home inspection reports) to evaluate various risks associated with home 130. Analytics computing device 150 may use numerous data points to evaluate such risks to a residential property and may compute a composite risk score and/or various focused risk scores for the property. The risk score (e.g., or likelihood of damage score) may be a numeric value and/or a category (e.g., excellent, good, fair, and poor).

Such risk scores may be used, for example, to prioritize recommended tasks for maintaining the home, to evaluate insurability of the property and its assets, to price insurance policy options for the property, or to provide policy discounts and verify compliance for risk mitigating changes, actions, or behaviors. Analytics computing device 150 may generate a risk score for different categories of risk, such as property risk, fire protection, and safety, which may be presented individually within the user interface with related recommendations. For example, the fire protection rating may be displayed along with fire-protection related recommendations, such as recommended tasks that may result in a reduction of fire risk if implemented.

### Exemplary Home Monitoring System

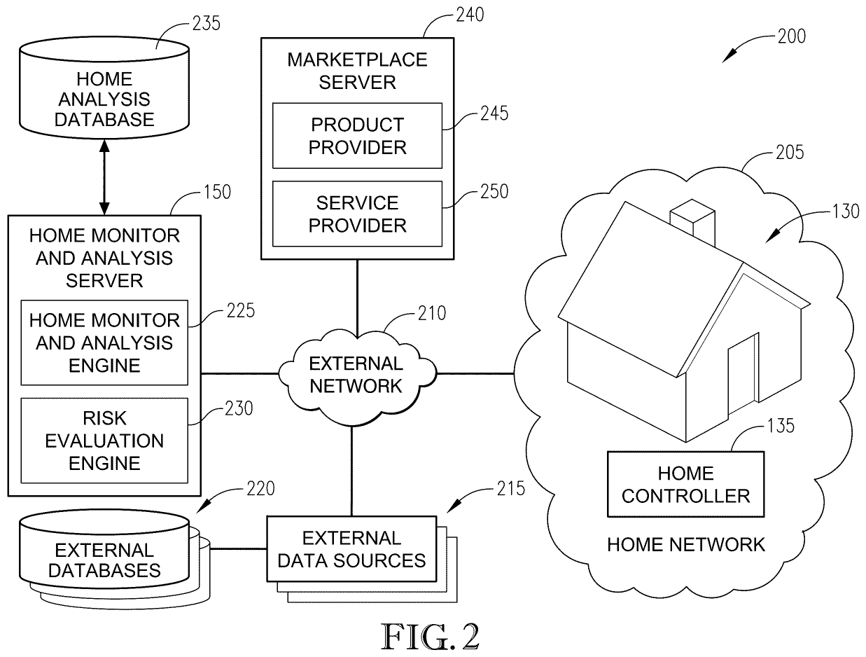

FIG. 2 illustrates an exemplary expanded system 200 that may be used for evaluating a home 130 and the risks associated therewith and providing recommendations, in accordance with the present disclosure. In the exemplary embodiment, the system 200 includes analytics computing device 150 that may be remote from the home, proximate to the home or within the home. Analytics computing device 150 may be configured to execute a home monitor and analysis engine 225 and a risk evaluation engine 230. Analytics computing device 150 may include or otherwise be in communication with a home analysis database 235 that stores information about the home 130 (e.g., home data, as described above), and may include information about real estate upon which the home 130 is located, assets contained within the home 130 (e.g., IoT devices 110), and various data points relating to home 130. The terms “house,” “home,” and “residential property” may be used interchangeably herein to refer to the home 130 and its various property and assets.

In the exemplary embodiment, analytics computing device 150 is in networked communication with home controller (or just “controller”) 135 of the home 130 through an external network 210 (e.g., the Internet). The home controller 135 may manage aspects of energy data collection, computations, and alerting as a part of system 100. The home controller 135 is connected to a home network 205 of the home 130 which allows communication with analytics computing device 150 through an external network 210 (e.g., the Internet). For example, the home 130 may include a local area network (“LAN”), a wireless network (e.g., Wi-Fi network), or some combination thereof that connects to the external network 210 (e.g., via a subscription service to an Internet service provider, or the like). In some embodiments, the home controller 135 may communicate via a wireless mobile network, such as a 3G, 4G, or 5G network.

The home network 205 may allow various devices within the home 130 to communicate over the home network 205, such as computing devices and Internet-of-Things (“IoT”) type devices 110 (shown in FIG. 1) (e.g., smart sensors, smart appliances, or the like). Such IoT devices 110 may be referred to herein as “connected home devices,” in that they are associated with the home 130 or otherwise a part of the home network 205. Some IoT devices 110 may participate in system 100 and/or system 200, for example, providing sensor data that may be used (e.g., by analytics computing device 150) to analyze home inspection reports relating to home 130, to generate recommendations, to generate risk scores, determine matches in the marketplace server 240, or other uses described herein.

In the exemplary embodiment, the systems 100 and 200 may allow homeowners to opt into or out of various aspects of data collection from IoT devices 110 (e.g., by device type, by type of data collected, by data use). For example, the homeowner may be presented with an individual login to the system 100 and 200 which may include an opt-in screen that allows the homeowner to view data collection and usage policy and select whether they wish to allow such usage, thereby protecting privacy of the homeowner.

Analytics computing device 150, in the exemplary embodiment, may collect some home data from one or more external data sources 215. The home monitor and analysis engine 225 or the risk evaluation engine 230 may, for example, collect data from publicly available sources or from private third-party sources about the particular subject home 130 or the area in which the home 130 is built (referred to herein as “the locality of the home”). For example, one external data source 215 may be the national weather service (“NWS”), a branch of the national oceanic and atmospheric administration (“NOAA”). The NWS collects, and makes publicly available, weather data for the United States of America and its outlying countries.

The system 100 and 200 may collect aspects of historical, current, or predictive weather data for a locality of the home 130 (e.g., storm, wind, lightning, flooding in the locality) and may use such data to, for example, evaluate the appliances installed in home 130. Such data from external data sources 215 is referred to herein as “external data.” Some external data sources 215 may maintain such external data in one or more external databases 220. Other examples of external data sources 215 and external data may be provided by manufacturer server 105 (shown in FIG. 1) in addition to those provided below, as well as various uses for such external data.

In the exemplary embodiment, analytics computing device 150 is in communication with a marketplace server 240 through the external network 210. The marketplace server 240 is a platform where businesses and/or individuals come together to sell products and services to the customer base of homeowners. The marketplace server 240 and analytics computing device 150 determine the needs of the users and then determines which product providers 245 (e.g., stores or individuals who have listed products for sale) and service providers 250 that may be of assistance to the user. For example, if analytics computing device 150 generates a recommended task based upon data extracted from a home inspection report, analytics computing device 150 may identify a service provider 250 that can perform the recommended task and provide a link to communicate with the service provider 250 to the homeowner (e.g., using user device 140). Similarly, if a recommended task requires purchasing a product (e.g., a replacement for a broken component in home 130), analytics computing device 150 may identify a product provider 245 that can provide the needed product and provide a link to communicate with the product provider 245.

In the exemplary embodiment, analytics computing device 150 may be operated by an insurance provider that provides insurance coverage for the home 130 (e.g., via a home insurance policy) or that provides participation in systems 100 and 200 as a home protection service for the homeowner. The insurance provider may be any individual, group of individuals, company, corporation, or other type of entity that may issue insurance policies for customers, such as a homeowners, renters, or personal articles insurance policy associated with the home 130 or an insured. For example, after signing up for a home insurance coverage, the insurance provider may provide the home controller 135 for installation in the home 130.

Although the present disclosure describes the systems and methods as being facilitated in part by the insurance provider, it should be appreciated that other non-insurance related entities may implement the systems and methods. Accordingly, it may not be necessary for the home 130 to have an associated insurance policy for the property owners to enjoy the benefits of the systems and methods.

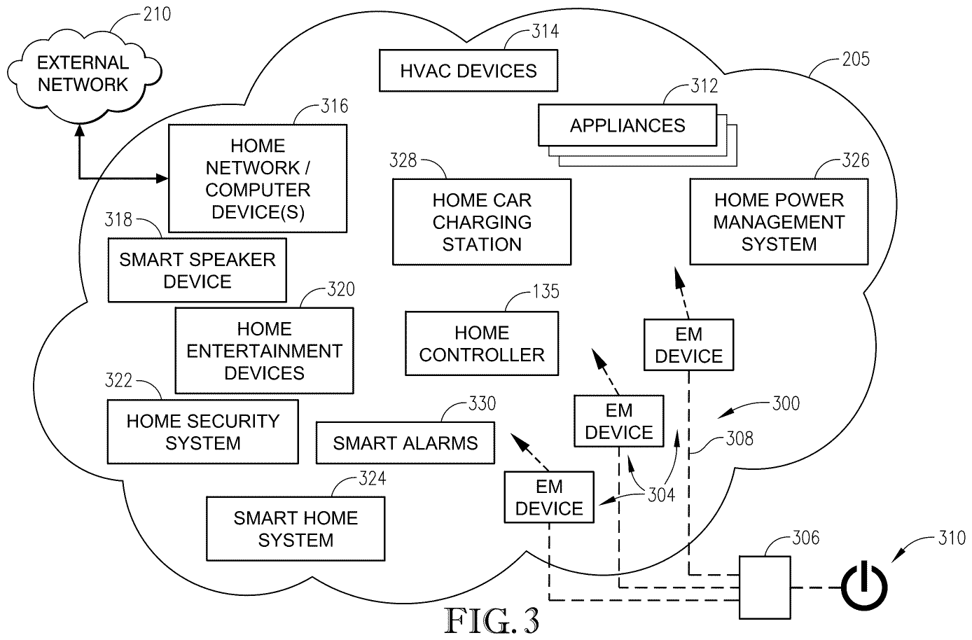

The home controller 135, as discussed in greater detail below, may be configured to collect home data, such as sensor data, from sensors, appliances, or other devices within the home 130, connect to the home network 205, and communicate with analytics computing device 150 and/or marketplace server 240. The home controller 135 may be configured to connect to the home network 205 and communicate with other networked IoT devices 110 (or “smart devices”) within the home 130. Such IoT devices 110 may be referred to herein as “source devices,” “connected devices,” or “IoT devices,” as devices that provide home data to the systems 100 and 200. In some embodiments, analytics computing device 150 may communicate directly with some or all of the source IoT devices 110 within the home 130. Various source devices are illustrated in further detail below with respect to FIG. 3.

In the exemplary embodiment, analytics computing device 150 provides the users access to the marketplace, while using ML and AI to determine which product providers 245 and service providers 250 are the most relevant to the user based upon the analysis of energy usage within their home 130. In at least some embodiments, analytics computing device 150 determines different attributes and/or conditions of home 130 based upon the home data provided from IoT devices 110 and/or the external data sources 215.

### Exemplary Source Devices

FIG. 3 illustrates exemplary source devices that may be used with the system 100 (shown in FIG. 1) and the system 200 (shown in FIG. 2). In the exemplary embodiment, home controller 135 is in communication with or otherwise monitors or collects data from a variety of source devices within the home network 205. Data derived from these source devices, such as sensor data, may be used by analytics computing device 150 to generate home data that is missing from a home inspection report and/or generate recommended tasks for addressing issues in home 130.

The home 130, and the various source devices therein, may be powered by an electrical distribution system 300. Paths of electrical power flow are illustrated in FIG. 3 in broken lines. The electrical distribution system 300 includes multiple electrical circuits 308, each of which may provide power to one or more of the source devices or other IoT devices 110 within the home 130. Each of the example circuits 308 emanate from an electrical distribution panel 306 that receives power from a power source 310, such as a utility power company or an on-premise power source (e.g., gas generator, solar generator, wind generator). Each circuit 308 may include a circuit breaker for each circuit 308 in the electrical distribution panel 306. While not expressly shown, any of the various source IoT devices 110 and/or other devices (not shown in FIG. 3) may be connected to and powered by the electrical circuits 308.

In the exemplary embodiment, the systems 100 and 200 may include one or more electricity monitoring (“EM”) devices 304. EM devices 304 may be used to monitor electricity flowing to individual electric devices, such as smart devices or appliances, electronics, vehicles, or mobile devices, and may be configured to monitor or detect abnormal usage or trends. Abnormal electricity flow (“EF”) to various devices may indicate that failure is imminent, maintenance or device replacement is needed, de-energization is recommended, or other corrective actions are prudent. For example, the EM devices 304 may be TING® smart sensors such as those made commercially available by Whisker Labs of Germantown, MD.

EF data collected by the EM devices 304 may include data indicative of electricity flow to or from various smart or other IoT devices 110 and/or other devices located in home 130, including the various devices shown here in FIG. 3. EF data may also include electricity or energy usage for each electronic component, device, outlet, circuit, or the like, within the home 130, such as data indicating the electricity each device or room is using. For example, energy usage of air conditioners, washers, dryers, dish washers, refrigerators, stoves, ovens, microwave ovens, televisions, lamps, outlets, computers, laptops, mobile devices, other electronic devices, may be determined by the EM device 304.

In addition to energy usage, EF data may be used to detect hazards or other abnormalities that may be correlated with a risk to the home 130 or its assets. For example, changes in electrical consumption (e.g., drawing more power and/or current than usual) of IoT devices 110 and/or other devices may indicate that IoT devices 110 and/or other devices are having problems that may influence a safety of home 130. Accordingly, EF data collected by the EM devices may be fed into the AI model as a factor in generating recommended tasks for home 130.

EM devices 304 may include sensors that are configured to monitor and collect EF data. EM devices 304 may be plugged into electrical outlets within the home (e.g., conventional 110-volt outlets) for at least powering the EM device 304 and/or IoT devices 110, or may be electrically wired into a circuit 308 for powering the EM device 304 and/or IoT devices 110. Further, some EM devices 304 may collect EF data directly from a circuit 308 (e.g., via wired connection to the circuit 308, referred to herein as “direct sensing”) and some EM devices 304 may wirelessly collect EF data from circuits 308, appliances, or other electricity consuming devices (referred to herein as “wireless sensing”).

Wireless sensing may include, for example, sensors within the EM device 304 that are configured to sense electromagnetic waves or an electrical signature of the electrical devices receiving power from the electrical distribution system 300. The EM devices 304 may directly or wirelessly detect each flow of electricity to or from each different electronic device by identifying each electronic device by its unique electronic or electrical signature (or “fingerprint”).

The EM devices 304 may then generate electricity usage or flow data for each electronic device within the home, or connected to the electrical distribution system 300 (such as a hybrid or fully electric vehicle having its battery directly or wirelessly charged by the home's electrical system). In some embodiments, EM devices 304 may be positioned in vicinity of the electrical distribution panel 306 and may capture electrical activity about the home 130 and/or devices installed in the home 130 by wirelessly detecting an electricity flow to devices that are coupled to the electrical distribution panel 306.

In other embodiments, EM devices 304 may be positioned in vicinity of the electrical distribution panel 306, but not hardwired to the electrical distribution panel 306 or home electrical wiring system, and may capture electrical activity about the home 130 and/or appliances installed in the home 130 by wirelessly detecting an electricity flow to devices that are coupled to the electrical distribution panel 306. In other embodiments, EM devices 304 may be plugged into electrical outlets positioned throughout a home.

During operation, as one or more of the electric devices receives electricity via the electrical distribution system 300, each device may be differentiated by an electrical signature that is unique to a respective device (such as by one or more EM devices 304 monitoring, detecting, and/or analyzing the electricity flowing to or being consumed by each respective electric device, and/or by monitoring EF data generated or collected by one or more EM devices 304).

In other words, transmission of electricity to a refrigerator, for example, may be differentiated from transmission of electricity to an electric stove (such as via one or more EM devices 304 and/or analyzing the EF data generated or collected by one or more EM devices 304). Furthermore, transmission of electricity to a television on one circuit 308 or outlet, for example, may be differentiated from transmission of electricity to another recipient electric device (e.g., a cable television box) via the same circuit 308 or electrical outlet. The systems 100 and 200 may correlate electrical activity with a variety of electric devices on the electrical distribution system 300 based upon electrical signatures unique to each respective device. The systems 100 and 200 may build a structural electrical profile for the home 130, which may include data indicative of operation of the various electric devices within or around the home 130 (e.g., over a period of time), such as by using EF data generated or collected by one or more EM devices 304 over a period of time.

In some embodiments, an EM device 304 may be affixed to or situated near the electrical distribution panel 306. Generally, the EM device 304 may utilize the unique, differentiable electrical signatures of the electric devices by directly or wirelessly monitoring electrical activity including transmission of electricity via the electrical distribution panel 306 to one or more of the electric devices. Monitoring of transmission of electricity to an electric device receiving the electricity may include, for example, monitoring (i) the time at which the electricity was transmitted, (ii) the duration for which the electricity was transmitted, and/or (iii) the magnitude of the electric current in the transmission.

Based upon the unique electrical signatures of the various electric devices of the home 130, the monitored electrical activity may be correlated with respective electric devices receiving the electricity transmitted via the electrical distribution system 300, enabling the electricity usage of the various devices to be tracked individually. Further, electrical activity associated with other components of the electrical distribution system 300 (e.g., the electrical distribution panel 306, the circuits 308, or the like) may be correlated with one or more electric devices to which the electrical activity also pertains.

In some embodiments, the EM device(s) 304 may perform the correlation or other functions described herein, via one or more processors of the EM device(s) 304 that may execute instructions stored at one or more computer memories of the EM devices 304. In other embodiments, the EM devices 304 may collect the EF data, and the correlation and/or other functions described herein may be performed at another system (e.g., the home controller 135 or analytics computing device 150), which may receive data or signals indicative of monitored electricity or other data via one or more processors or through transfer via a physical medium (e.g., a USB drive). Correlation of the electrical activity with the respective electrical devices may produce data indicating, for example, the time, duration, and/or magnitude of electricity consumption by each of the electric devices during a period of electrical activity monitoring.

Based upon at least the correlated electrical activity, a structure electrical profile may be built and stored at the EM devices 304 or at some other system (e.g., the home controller 135 or the home analysis database 235). The structure electrical profile may include, for each of the electric devices about the home 130, data indicative of operation of the respective electric device during at least the period at which the EM devices 304 monitored electrical activity about the home 130. Based upon the correlated electrical activity, the structure electrical profile may depict, for example, average electricity operation/usage, baseline electricity operation/usage, and/or expected electricity operation/usage/consumption. In effect, the structure electrical profile, based upon electrical activity about the structure, may set forth what is “normal” operation and usage of electricity about the structure.

Thus, once the structure electrical profile is built, any electrical activity monitored via the home controller 135 and the EM device(s) 304 may be analyzed to determine whether electrical activity is abnormal and/or otherwise indicative of a condition that my affect the electric devices. In response to the abnormal electrical activity, among other possible factors, corrective actions to improve the energy efficiency of the device, mitigate damage, prevent damage, and/or remedy the cause of the abnormal electrical activity the situation may be determined and/or initiated. Some possible corrective actions are discussed herein.

EF data regarding an electric device may include, for example, historical data indicating the electric device's past operation patterns or trends. For example, historical data may indicate a time of day, day of the week, time of the month, etc., at which an electric device frequently uses electricity (e.g., a lighting fixture may not use electricity during late night hours of the day). As another example, historical data may include the electric device's total electricity consumption or usage rate over a period of time. Additionally or alternatively, historical data may include data indicating past events regarding the electric device (e.g., breakdowns, power losses, arc faults, etc.).

Additionally or alternatively, operation data regarding an electric device may include an expected electricity consumption or baseline electricity consumption for the electric device. For example, in the case of a refrigerator, the refrigerator's electricity consumption during a first period of monitoring may be reliably used to approximate an expected electricity consumption at a later time. Changing electricity consumption over time (e.g., the refrigerator's consumption is greater than expected for a period) may indicate that the refrigerator is in need of repair and/or maintenance and/or operating sub-optimally.

Further, the structure electrical profile may include data pertaining to the structure as a whole. For example, the structure electrical profile may include data reflecting a total electricity or average usage rate over a period of time. As another example, the profile may include time-of-day, day-of-week, etc., data reflecting times at which the home 130 as a whole uses more or less electricity. Further, the profile may detail specific types, classes, or specifications of electric devices that behave differently or consume a different amount of electricity compared to other electric devices within the home 130. Further, the profile may detail specific risks determined to be relevant to one or more of the electric devices or to the home 130 as a whole, based upon the electrical activity of the electric devices.

Furthermore, the structure electrical profile may include a digital “map” of the home 130. A home map may indicate spatial locations of the electric devices, and/or spatial relationships between two or more of the electric devices. Such mapping may indicate, for example, a risk associated with the spatial placement of a stove, and/or a risk associated with placing a refrigerator adjacent to the stove.

Additionally or alternatively, the home map may indicate which of the electric devices are connected to each electrical circuit 308 within the electrical distribution system 300 of the home 130. Such mapping may indicate, for example, a risk of overloading a particular circuit 308 based upon a number or intensity of electric devices connected to the circuit 308. As another example, the home map may be used to determine what electric devices may lose power if a particular circuit 308 were to be de-energized (e.g., due to risk or abnormal electrical activity associated with one electric device on the circuit).

In some embodiments, the home map may be configurable by a user (e.g., the homeowner of the home 130). The user may, for example, configure the map via an I/O module (e.g., screen, keypad, mouse, voice control, etc.) of the home controller 135, or via an I/O module of another computing device, which may transmit the home map to the home controller 135. Additionally or alternatively, the home map may be stored at one or more computer memories of another system (e.g., analytics computing device 150).

In some embodiments, the home network 205 may include a home power management system 326. The home power management system 326, or home controller 135 in conjunction with the EM devices 304, may collect power consumption data on the circuits 308 (e.g., via EM devices 304) or device electrical usage data of various electronic devices within the home 130. The home power management system 326 may, for example, collect usage data for lights or appliances within the home 130, giving an indication of how much electricity the home 130 uses or how frequently occupants are at home. In some embodiments, the home 130 may include one or more smart plugs (not separately shown) which may be managed by home power management system 326, the smart speaker device 318, the smart home system 324, or otherwise by the systems 100 and 200 (e.g., for activating or deactivating devices plugged into the circuits 308 via the smart plugs, such as via 110-volt outlets).

The home power management system 326 may identify and provide details on what appliances or other consuming devices are within the home 130 (e.g., manufacturer make and model), thereby allowing the systems 100 and 200 to identify some property on the premises (e.g., device identification and verification, device count), evaluate value of devices (e.g., replacement costs), or collect manufacturer-provided or consumer protection-provided details regarding the devices from external data sources 215 (e.g., susceptibility of the device to power surges, likelihood of fire caused by the device, mean time to failure of the device, types of device failures, power consumption profiles and tolerances of the device, or the like).

The home power management system 326 may collect power quality data for the home 130, such as occurrences and frequency of power outages or reductions in service (e.g., black-outs or brown-outs), loading at various times throughout the day or week, the size of service, occurrences of voltage values fluctuating beyond tolerance ranges (e.g., spikes), or the like. In some embodiments, the home power management system 326 may include one or more smart circuit breakers (e.g., on any or all of the circuits 308) or a smart panel (e.g., as the electrical distribution panel 306), such as those made commercially available by Schneider Electric (Paris, France), which may provide circuit-level data and operations such as, for example, current or historical circuit load data, circuit breaker status, or turning circuit breakers on or off. Such power data may be used to construct a power profile for the home 130. In some embodiments, the home controller 135 may perform any such power monitoring and data collection operations in lieu of, or in addition to, the home power management system 326.

In the exemplary embodiment, the home 130 may include one or more smart appliances 312 (e.g., appliances that can communicate via the home network 205, which may include IoT devices 110). Smart appliances 312 may include, for example, dish washers, microwaves, stove tops, ovens, grills, clothes washers and dryers, water heater, water meter, water softener or purifier, smart lighting, smart window blinds or shutters, piping, interior or yard sprinklers, or the like. The home controller 135 may be configured to communicate with such smart appliances 312 and may collect home data from such appliances for the systems 100 and 200. In fact, all such collected data from the various devices within the home can be stored and used as home data.

For example, smart appliances 312 may provide data such as device data (e.g., manufacturer, make, model, date of manufacturer, date of installation, software or firmware versions), usage data (e.g., daily usage time, power consumption), or log data (e.g., log events, alerts, component failure detections, maintenance history, or the like). Such appliance data may allow the systems 100 and 200 to detect which appliances are present in the home 130 (broadly, as a part of an “asset inventory” of the house), their replacement value, age of each appliance, a maintenance history of each appliance, to detect when appliances or their components are failing.

Electrical distribution system 300 may use such data, for example, to construct the power profile for home 130, to compute an energy score for home 130, to compute a risk for the home 130 and/or the appliances, to compute in an insurance profile for the home 130 (e.g., as factors of risk to lightning or other hazards), or to alert the homeowners when an appliance registers a failure.

In the exemplary embodiment, the home 130 may also include smart HVAC devices such as, for example, a heater (e.g., a gas or electric furnace), an air conditioner, an air purifier, an attic fan, a ceiling fan. Some or all such devices may be controlled by a thermostat device. Such devices are collectively referred to herein as HVAC devices 314, some of which may not be smart devices but may nonetheless be controlled in some aspects by the thermostat device.

The systems 100 and 200 may collect HVAC data such as device data (e.g., manufacturer, make, model, date of manufacturer, date of installation), usage data (e.g., daily usage time, power consumption), or thermostat data (e.g., temperature settings, daily schedule profiles). The systems 100 and 200 may use such data, for example, to construct the power profile for the home 130, to compute an energy score and/or predicted energy cost, to compute a risk for the home 130 (e.g., determining how often the home 130 is typically occupied), to compute in an insurance profile for the home (e.g., as factors of risk to lightning or other hazards, likelihood of equipment failures), or to alert the homeowners when an HVAC device registers a failure. All this collected data may be stored as home data.

The home 130, in the exemplary embodiment, may also include various computing devices such as, for example, desktop or laptop personal computers, tablet computers, servers, or networking devices (e.g., Wi-Fi routers, switches, hubs, firewalls, or the like), all of which are collectively represented here as home network/computer devices (or just “computer devices”) 316. The networking devices may provide some or all of the home network 205 that is used to facilitate communication between the devices shown here.

The home controller 135 may be configured to capture computer device data from some or all of these home network computer devices 316 such as, for example, a number and type of computing devices (e.g., hardware manufacturer, make, model, and the like), hardware and software profile of computing devices, configuration data of computing devices (e.g., software versions, firmware versions), usage data, and log data (e.g., firewall logs, access logs, software patch logs, error logs). The systems 100 and 200 may use such data to, for example, determine asset inventory and valuation, construct the power profile for the home 130 (e.g., average daily usage), alert the homeowners when devices need software or firmware upgrades (e.g., critical security alerts) or upon intrusion detection or other compromise of home network computer devices 316 (e.g., software hacks).

In the exemplary embodiment, the home 130 may include a smart speaker device(s) (or “nest device”) 318 that may interact with occupants of the home 130 (e.g., via audible commands and responses, digital display, executing pre-configured actions). Some example smart speaker devices 318 include the Echo® devices (Amazon Inc., of Seattle, Washington) and the Google Nest® devices (Alphabet Inc., of Mountain View, California), to name but a few. The smart speaker device 318 may include a speaker for providing audio output, a microphone for receiving audio input (e.g., commands spoken by the occupants), and may include a display device for video output or a camera device for capturing video input. The smart speaker device 318 may be configured to interact with other smart devices, such as for controlling lighting within the home 130, the thermostat (e.g., changing thermostat settings), home security devices of a home security system 322 (e.g., locking and unlocking smart locks on doors, opening or closing garage doors, or the like), or entertainment devices of a home entertainment system 320 (e.g., enabling, disabling, or reconfiguring music or television devices).

The systems 100 and 200 may, with owner configuration and permission, utilize inputs from the smart speaker device 318 to, for example, determine a number of unique occupants of the home 130 (e.g., via unique speech profile or video identification), determine the number of children in the home 130 (e.g., via audio or video analysis), determine when occupants of the home 130 are currently or historically present (e.g., via noise detection, video movement), determine when other devices are turned on or off, determine presence of pets (e.g., via unique audio sounds or video identification of the pets), or smoke or carbon monoxide alarm detection (e.g., via audible sound). Such raw data may be sanitized or distilled by the home controller 135 into refined data before sending to analytics computing device 150 in an effort to protect privacy of the home occupants while still providing home health evaluation and risk capabilities (e.g., sending results determined from the raw audio or video data and deleting the raw audio or video data). The systems 100 and 200 may anonymize personal data, thereby allowing data to be stored or used without direct attribution of data to a particular homeowner.

In the exemplary embodiment, the home 130 may include various home entertainment devices 320 such as, for example, televisions, digital video recorders (“DVR”), radios, amplifiers, speakers, remotes, or console gaming systems, any or all of which may be smart devices in communication with the home network 205 and home controller 135. Home controller 135 may collect home entertainment data from such devices and may use that data, for example, to construct the power profile for the home 130, to compute an energy score and/or expected energy cost for home 130, to construct the asset inventory of the home 130, to compute a risk score for the home 130, to compute in an insurance profile for the home (e.g., as factors of risk to lightning or other hazards, likelihood of equipment failures).

The home 130, in the exemplary embodiment, may include a home security system 322. The home security system 322 may include security devices such as, for example, door or window sensors (e.g., to detect when doors or windows or open, when windows are broken), motion sensors (e.g., to detect when someone is present within range of the sensor), security cameras (e.g., for capturing audio/video of particular areas in or around the home 130, such as a doorbell camera), key pads (e.g., for enabling/disabling the security system), panic buttons (e.g., for alerting a security service or authorities of an emergency situation), security hubs (e.g., for integrating individual security devices into a security system, for centrally controlling such devices, for interacting with third parties), electric door locks, or smoke/fire/carbon monoxide detectors. Such “security devices” broadly represent devices that can detect potential contemporaneous risks to the home 130 or its occupants (e.g., intrusion, fire, health).

The home security system 322 may be configured to communicate with a third-party security service or local authorities, and may transmit alerts to such parties when events are detected. The home controller 135 may be configured to receive alert data from the home security system 322 and may transmit such alerts to analytics computing device 150, create historical logs of security events, or transmit alert events directly to the homeowner (e.g., via SMS text message or the like) or to local authorities, fire protection, or emergency services. The systems 100 and 200 may use such security alert events to, for example, determine how frequently security events occur (e.g., as a factor for risk), how often such events are warranted (e.g., authentic risks rather than false alarms), or the type and nature of such authentic risks or false alarms.

The systems 100 and 200 may use raw data collected directly from any of these security devices. For example, the home controller 135 may use raw data from the motion sensors to detect when the home 130 is occupied (e.g., to build a profile of occupancy times), may use raw data from the camera devices or door devices to detect when occupants enter or exit the home 130, may use the camera devices to determine a number of occupants of the home 130 or a number and type of pets in the home 130.

The home controller 135 may determine information about the home security system 322 installed within the home, such as a number and type of security sensors installed within the home 130, a type of home security system 322 installed in the home (e.g., third-party service provider, device manufacturers, types of security protection implemented within the home), or how often the homeowners leave the home 130 unoccupied without activating the home security system 322 (e.g., as a factor in risk calculations or home health scoring). The systems 100 and 200 may rate the home security system 322 and associated devices and services to generate a home security protection rating (e.g., relative to other available security systems or hardware) and may use that rating as a factor in risk calculations or in preparing a risk mitigation proposal (e.g., for more or better devices or security systems).

In some embodiments, the home 130 may include a smart home system 324 (e.g., a home monitoring system) that allows the homeowner and occupants to control various devices within the home 130. For example, the smart home system 324 may be configured to control, inter alia, devices such as the smart appliances 312, HVAC devices 314, home entertainment devices 320, or home security system 322. In the exemplary embodiment, the home controller 135 may be configured to interact directly with such devices as described herein (“direct access”), or may be configured to perform some interactions and data collections with such devices through the smart home system 324 (“proxy access”). For example, any or all of the data collections or operations described herein may be performed by the smart home system 324 based upon commands received from the home controller 135, thereby allowing the systems 100 and 200 to perform such operations through the smart home system 324 acting as a proxy for some such operations.

In the exemplary embodiment, the home 130 may include a home car charging station 328 that may be used to recharge electric vehicles. The home car charging station 328 may draw power from one or more of the circuits 308 of the electrical distribution system 300 and may include an on-premise power source (e.g., solar panels, wind generator, or the like) or a dedicated battery bank (e.g., for storing excess power from the local energy source). The systems 100 and 200 may capture various charging station data from the home car charging station 328, from the circuits 308 used for home car charging station 328, or from the local power source device(s).

In the exemplary embodiment, the home 130 may include one or more smart alarms 330 that are configured to detect various conditions within the home 130 and may alert the homeowner or other occupants (e.g., via audible alarm, SMS text message, email, or the like). Smart alarms 330 may include, for example, smoke detectors, carbon monoxide detectors, carbon dioxide detectors, or indoor air quality (“IAQ”) monitors or systems that include sensors configured to, for example, detect dangerous conditions such as fire or buildup of carbon monoxide, the presence of dangerous pollutants such as radon or various volatile organic compounds (“VOC”), or collect various air quality data such as temperature and humidity. Smart alarms 330 may include water leak detectors or flood alarms that may be configured to detect the presence of water at various areas in the home 130, such as near HVAC equipment, water tanks, sump pumps, below showers or bathtubs, around basement perimeters, behind or within basement walls, or the like. Such water detectors may identify leaks within plumbing or appliances within the home 130 or ingress of water into the home 130 (e.g., rain water, flooding, failing sump pump, foundation cracks, or the like).

System 100 may collect alarm data from the smart alarms 330 and may perform automatic alerting based upon sensor events registered at such smart alarms 330 (e.g., alerting emergency services, homeowner, or the like, in an effort to protect life and property, mitigate damage, or such) or initiate automatic actions (e.g., shutting off water flow within the home 130, or within a particular segment of plumbing, via activating a smart water shut off valve, not separately shown). The systems 100 and 200 may identify the presence of such smart alarms 330 or shut off valves in the home 130 when configured to communicate with the smart alarms 330 and may automatically provide policy discounts when particular smart alarms 330 are detected as present or may include the presence or absence of such smart alarms 330 in the various aspects of home health scoring. Furthermore, analytics computing device 150 may be configured to provide marketplace suggestions of provides to assist with the issues that are associated with the alarms.

Data received from smart alarm 330 may be used to detect hazards or other abnormalities that may be appropriate to include in a home inspection report, a need to repair or replace certain IoT devices 110 and/or other devices, and/or indicate a risk to home 130 or its assets, and may be used to generate recommended tasks. For example, if smart alarm 330 is triggered based upon poor air quality in home 130, it may be determined that there is an issue with certain appliances such as HVAC devices 314, fans, and/or air purifiers.

### Exemplary External Data Sources

In the exemplary embodiment, and referring now to FIG. 2, the system 200 may collect various types of external data from external data sources 215 that may be used, for example, for identifying home data relating to home 130 (e.g., data identified as missing from a home inspection report), generate recommended tasks for home 130, and/or other various uses described herein. For example, the machine learning model or AI model may identify correlations between any of the data types described herein and potential issues in a home, and therefore may use any of these data sources as factors in generating recommended tasks for addressing these issues. Some external data sources 215 may provide publicly available data, where other external data sources 215 may be private, third-party sources.

External data sources 215 may include an insurance provider that provides insurance policies to the homeowner and various data available or otherwise collected by that insurance provider. In some embodiments, Analytics computing device 150 may be operated by the insurance provider and the data may include data private to the insurance provider (e.g., customer data, policy information, or other proprietary information).

In the exemplary embodiment, one example external data source 215 is the NOAA or any of its various branches (e.g., the national weather service). The NOAA makes various weather data publicly available. As such, the system 200 may collect weather data from the NOAA. Such weather data may be refined to a particular geography, such as a state, county, city, or other geographic region. The system 200 may, for example, identify a geographic region of the home 130 and submit data queries to the NOAA for weather data specific to that geographic region. Such data queries may include requests for historical data such as average rainfall, storm occurrences, wind strengths, lightning strikes, temperatures, tornado events, or the like.

Data queries may include requests for forecast data such as severe watches warnings, tornado watches or warnings, flooding watches or warnings, precipitation predictions, wind predictions, lightning event predictions, blizzard warnings, or the like. Forecast data may be used to, for example, generate and send weather alerts to the homeowner or occupants of the home 130 or determine how frequently the home 130 experiences various warnings or alerts over time. In some embodiments, the machine learning model or AI model may identify correlations between weather data and certain issues that may occur in home 130, and therefore may use such data as a factor in generating recommended tasks for home 130.

In the exemplary embodiment, another example external data source 215 may be the U.S. Forest Service. The U.S. Forest Service maintains historical data related to forest fires and tracks active forest fires in the United States. As such, system 100 may collect forest fire data from the U.S. Forest Service. Such forest fire data may similarly be refined to a particular geography, such as a state, county, city, or other geographic region. The system 200 may, for example, collect historical forest fire data for the geographic region of the home 130, or may collect current forest fire data at or near the location of the home 130 (e.g., within a pre-defined distance from the home, within a distance from a projected path of the forest fire). System 200 may use current forest fire data to, for example, generate and send forest fire alerts to the homeowner or occupants of the home 130, or as factors in home health scoring. In some embodiments, the machine learning model or AI model may identify correlations between forest fire data and certain issues that may occur in home 130, and therefore may use such data as a factor in generating recommended tasks for home 130.

In the exemplary embodiment, another example external data source 215 may be municipal power utilities. Electrical distribution system 300 may access current or historical power network data provided by power utility companies in various localities, such as power generation performance statistics (e.g., generation and load statistics), power transmission and distribution statistics or power outage information (e.g., across the network, local to a distribution segment that services the home 130, consistencies of voltages, power sags, power surges, brown-outs or black-outs and associated frequencies or lengths of outages, or the like), lightning strike data affecting the power network, or electrical consumption data for the home 130 (e.g., current or historical power usage, local power generation provided back to the network). System 100 may use current power network data to, for example, generate and send alerts to the homeowner during power outages (e.g., as SMS text messages or emails that can be viewed on mobile computing devices). In some embodiments, the machine learning model or AI model may identify correlations between power network data and certain issues that may occur in home 130, and therefore may use such data as a factor in generating recommended tasks for home 130.

In the exemplary embodiment, another example external data source 215 may be third-party appliance data systems such as Multiple Listings Service (“MLS”), Zillow (www.zillow.com), or other Internet-accessible sources for property data. The system 200 may access such appliance data systems to collect construction details about the home 130 such as, for example, the age of the home, how many bedrooms and bathrooms the home 130 has, the type of any HVAC, the square footage of the home 130, the size of the property, market price of the home, whether the home 130 is constructed of wood, brick, concrete, or the like, the type and size of any garage, the quality of materials used to construct the home 130, whether the home 130 has a basement, the type, age, or condition of plumbing or wiring inside and outside the home 130, whether the home 130 has a pool and safety fence around the pool, the type of roofing, the floor plan, the architecture of the home 130 (e.g., ranch, two story, split foyer), the type of flooring, the type of exterior (e.g., wood, brick, siding), type of local power generation on the property (e.g., solar, wind, generator), number of fire places, type of fencing or gutters, whether the home 130 has a pool, sheds, patios, porches, or other exterior structures, whether the home 130 has outside doors having steps, type of ducting and insulation within the home 130, type of landscaping around the home 130, or mobility or accessibility options within the home 130. The analytics computing device 150 may use the real-estate data to compare to other homes 130 that may be similar and/or have similar features. These features may include, but are not limited to, pools, solar panels, sprinkler systems, and other systems around the home 130.

Some home statistics data may include geographic data about the home 130 such as, for example, school district information (e.g., public school system, school ratings), utility providers available to at the location (e.g., electric, gas, sewer, waste, recycling, phone, Internet, television, fire, police, hospital, or other city services), proximity data to various services and amenities (e.g., distances from schools, parks, grocery, gas, library, or sources of entertainment), hazard data for the area (e.g., crime statistics, natural disaster statistics, ratings for emergency services), Some home statistics data may include historical data, such as price history (e.g., sales history, listings history), public tax history, insurance claims history, home warranty information, home inspection information, lease information (e.g., whether and how often the home 130 has been partially or fully rented or leased), or the like. Some home statistics data may include home energy data such as, for example, whether the home 130 is energy certified, type and size of power generation, home appliance or lighting energy certification data, or the like. In some embodiments, the machine learning model or AI model may identify correlations between property data and/or home statistics data and certain issues that may occur in home 130, and therefore may use such data as a factor in generating recommended tasks for home 130.

In the exemplary embodiment, another example external data source 215 may be an insurance provider or other service provider that has an economic or consumer relationship with the homeowner. The system 200 may access the service provider systems to collect demographic details about the home 130 and its occupants, such as, for example, names or ages of the occupants, education levels or occupations of the occupants, whether any of the occupants smoke, a family emergency plan, community engagement of the occupants, or whether a business is operated out of the home 130.

The service provider system may collect home maintenance data about the home 130 such as, for example, maintenance logs of operations performed on the home 130 (e.g., service calls, property damage and fixes, routine device maintenance, cleanings, bug or pest service, lawn or garden service, roofing replacement, or the like), equipment installations and removals, device warranty information, or home improvements (e.g., new deck, pool, room(s), interior or exterior painting or weather proofing, solar installation, water reclamation systems installation, room remodeling, or the like).

The service provider system may collect home configuration data about the home 130 such as, for example, whether GFCI outlets or LED lights are installed in the home 130, whether power strips supporting multiple devices are in use, whether the home 130 has exercise equipment, types of grills or fryers installed in the home 130, whether the home 130 includes particular safety equipment (e.g., smoke or carbon monoxide detectors, fire extinguishers, deadbolts on exterior doors, water sensors, sump pump, or the like), paint colors used on various walls of the home 130. In some embodiments, the machine learning model or AI model may identify correlations between maintenance data and certain issues that may occur in home 130, and therefore may use such data as a factor in generating recommended tasks for home 130.

In some embodiments, the service provider may be the operator of analytics computing device 150 and the homeowner may provide such data via an input interface (e.g., online questionnaire, user interface, service application, or the like, during participation in the home health system described herein). Collection and use of such data may be opted into by the homeowner on behalf of the occupants. In some embodiments, the system 200 may query the homeowner for any data elements described herein and not otherwise automatically accessed by the system 200.

In the exemplary embodiment, the system 200 may access aerial data of the home 130, such as satellite-, aerial-, or drone-captured overhead images of the home 130 and surrounding property. Such aerial data may be used to determine various externally visible features of appliance data (e.g., via digital image processing, machine learning, or human analysis). For example, system 200 may use aerial data to determine structural elements of the home 130 or surrounding property, such as whether the home 130 has a swimming pool, a fence, or a deck, how many garages the home 130 has, or the like. For example, in one embodiment, system 200 may determine that additional data is needed regarding the roof of the home in order to complete the home data from the home inspection report. The system may cause aerial data to be retrieved from a drone or satellite of the home's roof so that the data can be further analyzed by the system to determine if repairs are needed for the home's roof.

The system 200 may use aerial data to determine whether the home 130 has trees nearby (e.g., which may cause damage to the home 130) or whether the home 130 is located on a cul-de-sac or a busy road. Such aerial data may be provided by a third party or public external data source 215 (e.g., United States Geological Survey (“USGS”), National Aeronautics and Space Administration (“NASA”), NOAA, Google®, or the like) or may be privately collected (e.g., via aerial or drone photography of the home 130 by the insurance provider, realtor, or the like). Such aerial data may include global positioning system (“GPS”) location data for the home 130. In some embodiments, the machine learning model or AI model may identify correlations between aerial data and certain issues that may occur in home 130, and therefore may use such data as a factor in generating recommended tasks for home 130.

The system 200 may train a model of satellite images of homes 130 with labeled data of the homes 130 indicating, for example, whether the homes 130 have pools, decks, nearby trees, or other such features. As such, the trained model may be configured to automatically evaluate an unlabeled home (e.g., the home 130 in FIG. 1) to determine whether such features are present or otherwise categorize the home 130 with respect to those features.

In some embodiments, the system 200 may access mapping data around the home 130 to determine various home health features. The system 200 may utilize a web mapping service (e.g., Google® Maps or the like) as an external data source 215. For example, the system 200 may access the web mapping service via an application programming interface (“API”) that allows system 200 to submit, for example, the postal address of the home 130 or a GPS coordinate of the home 130 and query the web mapping service to provide features such as distances to nearby services (e.g., distance to nearest hospital, fire department, police station, schools, places of worship, parks, grocery stores, to various types of entertainment or other amenities, or the like). Mapping data may be used to determine whether the home 130 is situated on a busy or isolated road. The system 200 may generate a play score for the home 130 using the mapping data, where the play score evaluates proximity of the home 130 to various types of entertainment or exercise venues, such as proximity to hiking trails, bike paths, sports fields, professional sports venues, restaurants, theaters, or the like).

The mapping data may include ground-level imagery provided by the web mapping service that may be used by the system 200 to evaluate various externally visible features of appliance data (e.g., via digital image processing, machine learning, or human analysis). For example, the system 200 may use ground-level imagery to determine structural features of the home 130 such as a number of stories of the home, type of windows installed in the home, a roof type or type of exterior of the home, or how many garages the home has. The system 200 may train a model of ground-level images of homes 130 with labeled data of the homes 130 indicating, for example, how many stories or garages the homes 130 have, what type of exterior or roof type the homes 130 have, or other such features.

As such, the trained model may be configured to automatically evaluate an unlabeled home (e.g., the home 130 in FIG. 1) to determine whether such features are present or otherwise categorize the home 130 with respect to those features. In some embodiments, the machine learning model or AI model may identify correlations between mapping data and certain issues that may occur in home 130, and therefore may use such data as a factor in generating recommended tasks for home 130.

### Exemplary Server Computing Device

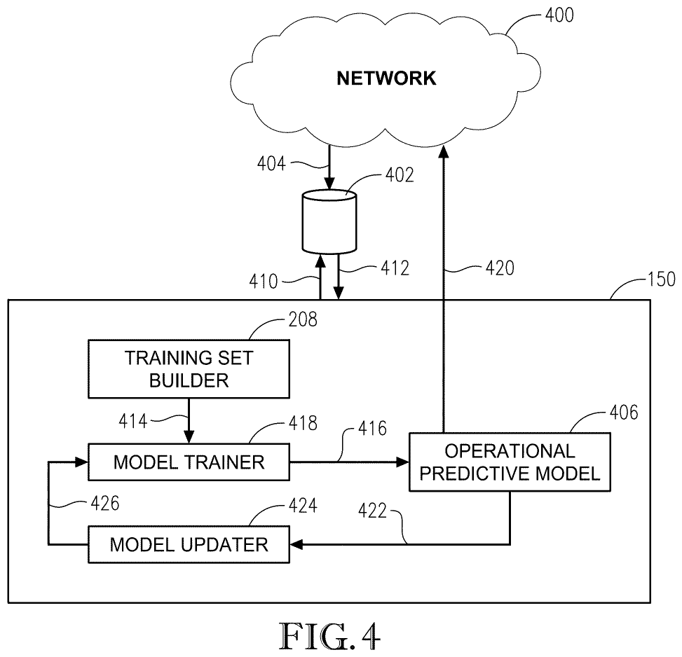

FIG. 4 is a schematic diagram illustrating further detail of analytics computing device 150 (shown in FIG. 1). Analytics computing device 150 may communicate with other components of system 100, such as manufacturer servers 105, IoT devices 110, home controllers 135, and/or user devices 140, via a network 400. Server computing device may include and/or be in communication with a database 402 that stores data 404 including home data, home inspection reports, and other information relevant to generating recommendations relating to home 130. Data 404 received from network 400 may be stored in database 402. Analytics computing device 150 may configured to use data 404 to generate an operational predictive model module 406 for predicting data values and/or generating recommendations relating home 130 as described herein.

In exemplary embodiments, analytics computing device 150 includes a training set builder module 208 configured to submit one or more queries 410 to database 402 to retrieve subsets 412 of data 404, and to use those subsets 412 to build training data sets 414 for generating operational predictive model 416. For example, query 410 may be configured to retrieve certain fields from data 404 for homes 130 having certain similar aspects, such as having a same builder, size, style, age, and/or being located in similar (e.g., nearby) geolocations.

In exemplary embodiments, training set builder module 208 may be configured to derive training data sets 414 from retrieved subsets 412. Each training data set 414 corresponds to a historical data 404 (“historical” in this context means completed in the past, as opposed to completed in real-time with respect to the time of retrieval by training set builder module 122). Each training data set 414 may include “model input” data fields along with at least one “result” data field representing historical feedback, such as reports relating to repairs, maintenance, and/or insurance claims in the area of homes 130, feedback received from homeowners, and/or decisions made by homeowners based upon previous recommendations (e.g., whether homeowners performed recommended maintenance actions). The model input data fields represent factors that may be expected to, or unexpectedly be found during model training to, have some correlation with data values and/or issues relating to homes 130.

In exemplary embodiments, the model input data fields in training data sets 414 may be generated from data fields in subset 412 corresponding to historical data 404. In other words, a trained machine learning model 416 produced by a model trainer module 418 for use by operational predictive model module 406 is trained to make predictions based upon input values that can be generated from the data fields in data 404. Values in the model input data fields may include values copied directly from values in a corresponding data field in the retrieved subset 412, and/or values generated by modifying, combining, or otherwise operating upon values in one or more data fields in the retrieved subset 412. Values in the model input data fields may include homes 130, historical home data relating to homes 130, and/or historical home inspection reports. The use of such data fields as model input data fields facilitates the machine learning model in weighing these factors directly.

After training set builder module 208 generates training data sets 414, training set builder module 208 passes the training data sets 414 to model trainer module 418. In example embodiments, model trainer module 418 is configured to apply the model input data fields of each training data set 414 as inputs to one or more machine learning models. Each of the one or more machine learning models is programmed to produce, for each training data set 414, at least one output intended to correspond to, or “predict,” a value of the at least one result data field of the training data set 414. “Machine learning” refers broadly to various algorithms that may be used to train the model to identify and recognize patterns in existing data in order to facilitate making predictions for subsequent new input data.

Model trainer module 418 is configured to compare, for each training data set 414, the at least one output of the model to the at least one result data field of the training data set 414, and apply a machine learning algorithm to adjust parameters of the model in order to reduce the difference or “error” between the at least one output and the corresponding at least one result data field. In this way, model trainer module 418 trains the machine learning model to accurately predict the value of the at least one result data field.

In other words, model trainer module 418 cycles the one or more machine learning models through the training data sets 414, causing adjustments in the model parameters, until the error between the at least one output and the at least one result data field falls below a suitable threshold, and then uploads at least one trained machine learning model 416 to operational predictive model module 406 for application to generating predictions 420. In example embodiments, model trainer module 418 may be configured to simultaneously train multiple candidate machine learning models and to select the best performing candidate for each result data field, as measured by the “error” between the at least one output and the corresponding result data field, to upload to operational predictive model module 406.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 418 cycles through the training data sets 414, model trainer module 418 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 418 provides an advantage by automatically discovering and properly weighting complex, second- or third order, and/or otherwise nonlinear interconnections between the model input data fields and the at least one output. Absent the machine learning model, such connections are unexpected and/or undiscoverable by human analysts.

In exemplary embodiments, operational predictive model module 406 may compare feedback (e.g., feedback received from homeowners, and/or decisions made by homeowners based upon previous recommendations) and may route a comparison result 422 generated by comparing prediction 420 to the feedback to a model updater module 424 of analytics computing device 150. Model updater module 424 is configured to derive a correction signal 426 from comparison results 422 received for one or more predictions 420, and to provide correction signal 426 to model trainer module 418 to enable updating or “re-training” of the at least one machine learning model to improve performance. The retrained at least one machine learning model 416 may be periodically re-uploaded to operational predictive model module 406.

Furthermore, the analytics computing device 150 may use data from one or more external data sources 215 (shown in FIG. 2) as historical data 404, training data sets 414, validation data, and/or other data as needed during the training, retraining, and/or execution of the one or more AI models.

In some embodiments, the analytics computing device 150 trains multiple models, wherein each model is for analyzing a different device, device type, location, home type, and/or any other variation or division desired to improve the operation of the systems 100 and 200 described herein.

### Exemplary Computer System

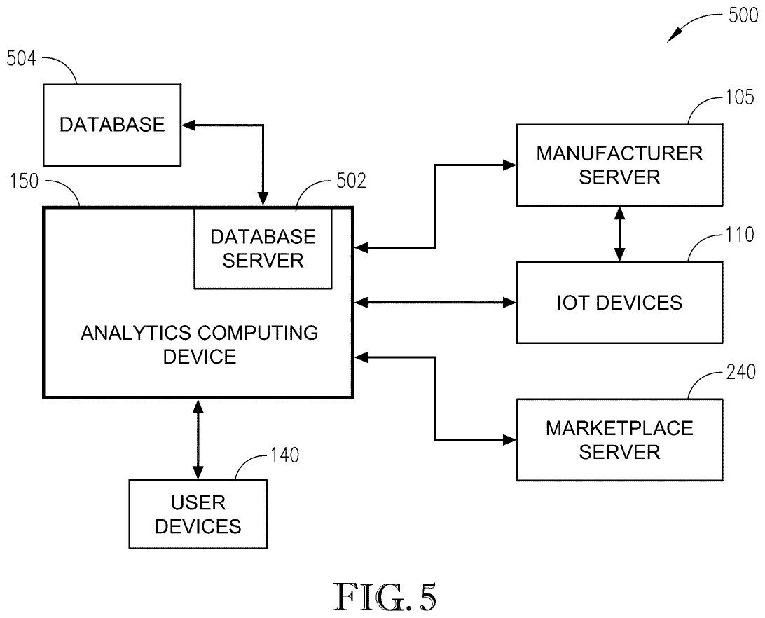

FIG. 5 illustrates an exemplary computer system 500 for implementing system 100 (shown in FIG. 1). In the exemplary embodiment, computer system 500 is used for generating AI-based recommendations for utilizing artificial intelligence tools to extract and augment data from a home inspection report and generate home recommendations in accordance with at least one embodiment of this disclosure. In the exemplary embodiment, user devices 140 are computers that include a web browser or a software application, which enables user devices 140 to communicate with analytics computing device 150 using the Internet, a local area network (LAN), or a wide area network (WAN). In some embodiments, user devices 140 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 140 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, IoT devices 110 are computers that may include a web browser or a software application, which enables IoT devices 110 to communicate with analytics computing device 150 using the Internet, a local area network (LAN), or a wide area network (WAN). In some embodiments, the IoT devices 110 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. IoT devices 110 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In the exemplary embodiment, IoT devices 110 as devices connected to the home network 205 (shown in FIG. 2) that provide information about the home 130.

In the exemplary embodiment, manufacturer servers 105 are computers that may include a web browser or a software application, which enables manufacturer servers 105 to communicate with associated source IoT devices 110 and analytics computing device 150 using the Internet, a local area network (LAN), or a wide area network (WAN). In some embodiments, the manufacturer servers 105 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The manufacturer servers 105 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, marketplace servers 240 are computers that may include a web browser or a software application, which enables marketplace servers 240 to communicate with associated the analytics computing device 150 using the Internet, a local area network (LAN), or a wide area network (WAN). In some embodiments, the marketplace servers 240 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The marketplace servers 240 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, analytics computing device 150 is a computer that may include a web browser or a software application, which enables analytics computing device 150 to communicate with user devices 140 using the Internet, a local area network (LAN), or a wide area network (WAN). In some embodiments, analytics computing device 150 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Analytics computing device 150 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 502 is communicatively coupled to a database 504 that stores data. In one embodiment, the database 504 is a database that includes appliance data, sensor data, trained models, property data, and/or recommendations. In some embodiments, the database 504 is stored remotely from the analytics computing device 150. In some embodiments, the database 504 is decentralized (e.g., implemented using cloud resources). In the example embodiment, a person can access the database 504 via user devices 140 by logging onto analytics computing device 150. In some embodiments, database 504 is similar to one or more of external databases 220, home analysis database 235 (both shown in FIG. 2), and database 402 (shown in FIG. 4).

### Exemplary Client Device

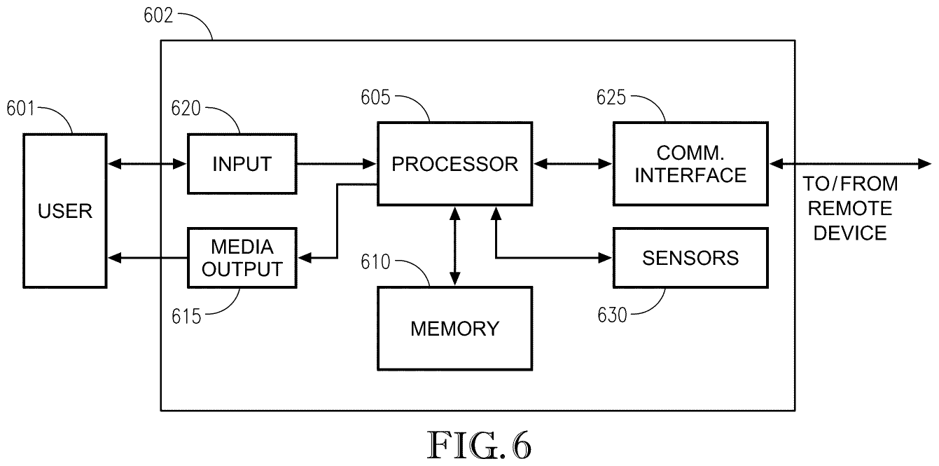

FIG. 6 depicts an exemplary configuration of a client computer device shown in FIG. 5, in accordance with one embodiment of the present disclosure. User computer device 602 may be operated by a user 601. User computer device 602 may include, but is not limited to, user device 140, IoT devices 110, IoT washer cameras 115, IoT thermostat 120, IoT door locks 125, (all shown in FIG. 1), EM devices 304, appliances 312, HVAC devices 314, home network computer devices 316, smart speaker devices 318, home entertainment devices 320, home security system 322, smart home system 324, home power management system 326, and/or home car charging station 328 (all shown in FIG. 3). User computer device 602 may include a processor 605 for executing instructions. In some embodiments, executable instructions are stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer-readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets), and/or voice or chat bots.

In some embodiments, media output component 615 may be configured to present a graphical user interface (e.g., a web browser and/or a client application) to user 601. A graphical user interface may include, for example, an interface for describing maintenance actions to be performed on one or more appliances 312 that will extend the lifecycle of the appliance 312. In some embodiments, user computer device 602 may include an input device 620 for receiving input from user 601. User 601 may use input device 620 to, without limitation, provide make and model information about an appliance 312.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as the analytics computing device 150 (shown in FIG. 1) and/or the marketplace server 240 (shown in FIG. 2). Communication interface 625 may include, for example, a wired or wireless network adapter and/or a wireless data transceiver for use with a mobile telecommunications network.

Stored in memory area 610 are, for example, computer-readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from the analytics computing device 150 and/or the marketplace server 240. A client application allows user 601 to interact with, for example, analytics computing device 150 and/or the marketplace server 240. For example, instructions may be stored by a cloud service, and the output of the execution of the instructions sent to the media output component 615.

Processor 605 executes computer-executable instructions for implementing aspects of the disclosure. In some embodiments, the processor 605 is transformed into a special purpose microprocessor by executing computer-executable instructions or by otherwise being programmed.

### Exemplary Server Device

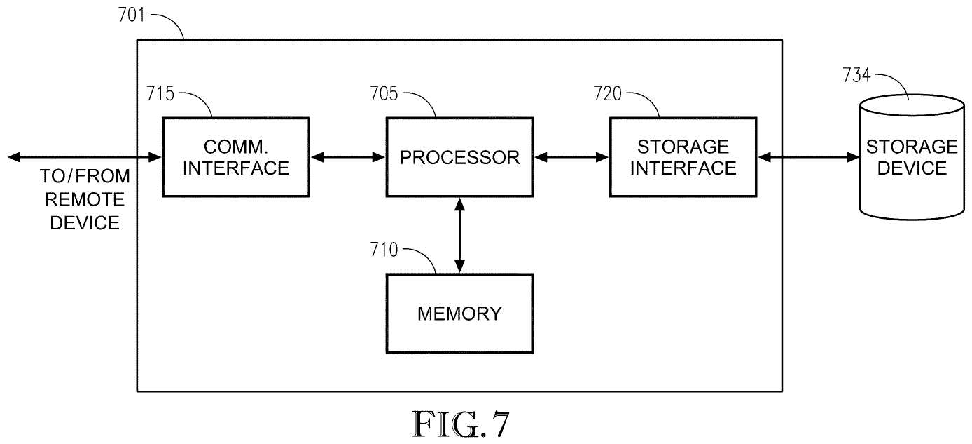

FIG. 7 depicts an exemplary configuration of a server computing device 701, in accordance with one embodiment of the present disclosure. Server computing device 01, but is not limited to, analytics computing device 150 (shown in FIG. 1), external data sources 215, marketplace server 240 (both shown in FIG. 2), home security system 322, smart home system 324, and/or home power management system 326, (all shown in FIG. 3). Server computer device 701 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 may be capable of communicating with a remote device such as another server computer device 701. For example, communication interface 715 may receive requests from user device 140 via the Internet, as illustrated in FIG. 5.

Processor 705 may also be operatively coupled to a storage device 734. Storage device 734 may be any computer-operated hardware suitable for storing and/or retrieving data, such as, but not limited to, data associated with database 402 (shown in FIG. 4). In some embodiments, storage device 734 may be integrated in server computer device 701. For example, server computer device 701 may include one or more hard disk drives as storage device 734.

In other embodiments, storage device 734 may be external to server computer device 701 and may be accessed by a plurality of server computer devices 701. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 705 may be operatively coupled to storage device 634 via a storage interface 720. Storage interface 720 may be any component capable of providing processor 605 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

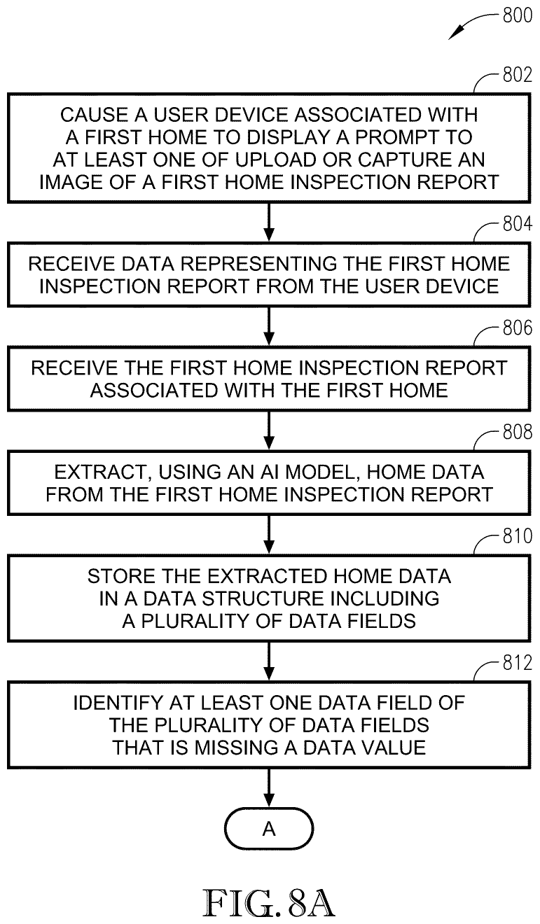

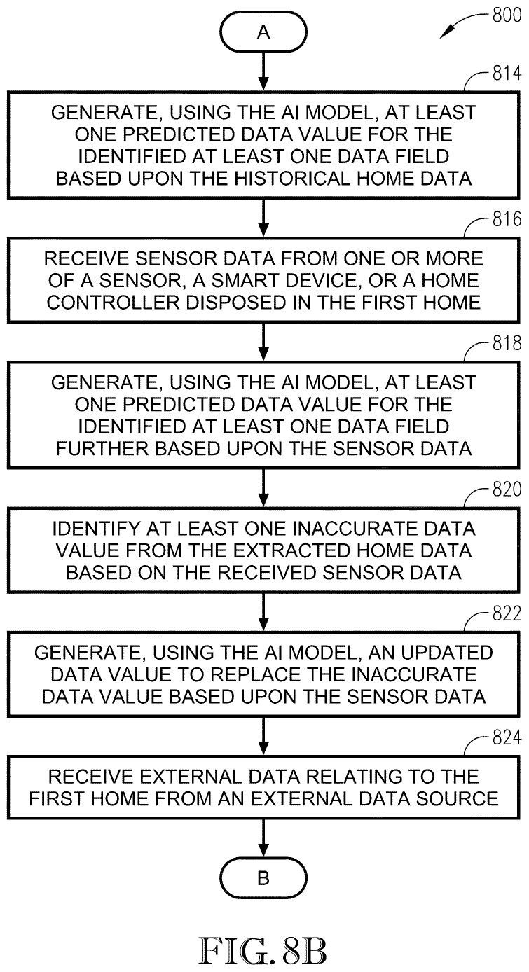

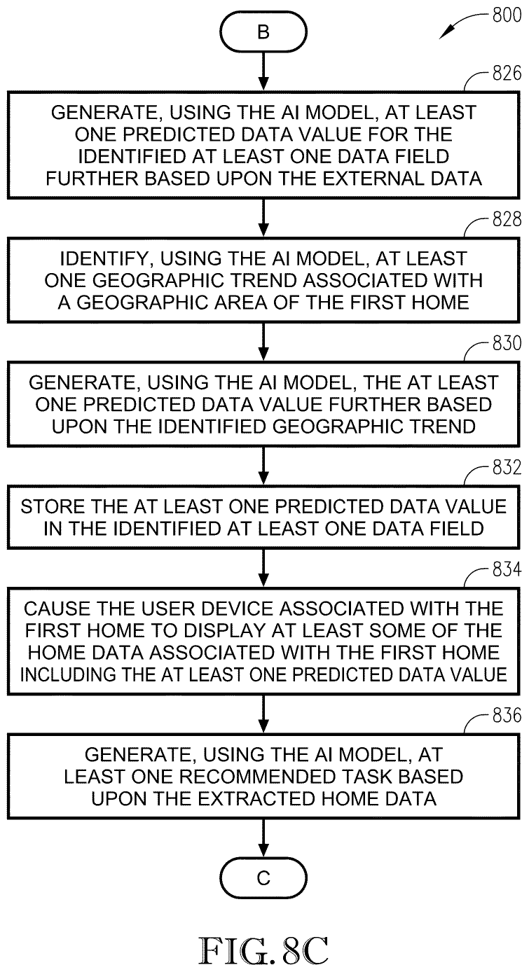

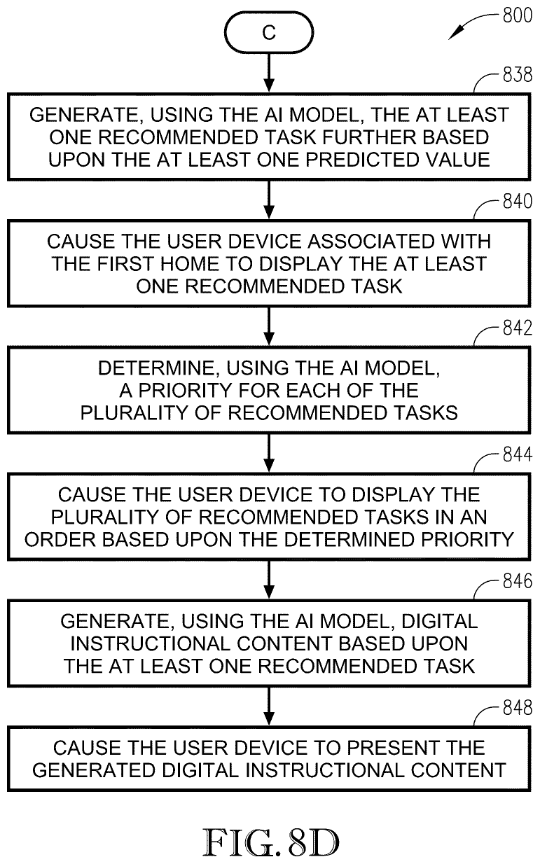

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instructions such as illustrated in FIGS. 8A-8D.

### Exemplary Computer-Implemented Method

FIGS. 8A-8D depict a flow chart of an exemplary computer-implemented method 800 for utilizing artificial intelligence tools to extract and augment data from a home inspection report and generate home recommendations using system 100 (shown in FIG. 1).

In certain embodiments, analytics computing device 150 may cause (Block 802) user device 140 associated with a first home 130 to display a prompt to at least one of upload or capture an image of a first home inspection report and may receive (Block 804) data representing the first home inspection report from the user device.

In the exemplary embodiment, analytics computing device 150 may receive (Block 806) the first home inspection report associated with the first home 130.

In the exemplary embodiment, analytics computing device 150 may extract (Block 808), using an AI model, home data from the first home inspection report, the AI model trained based upon historical home inspection reports and historical home data.

In the exemplary embodiment, analytics computing device 150 may store (Block 810) the extracted home data in a data structure including a plurality of data fields.

In the exemplary embodiment, analytics computing device 150 may identify (Block 812) at least one data field of the plurality of data fields that is missing a data value.

In the exemplary embodiment, analytics computing device 150 may generate (Block 814), using the AI model, at least one predicted data value for the identified at least one data field based upon the historical home data.

In some embodiments, analytics computing device 150 may receive (Block 816) sensor data from one or more of a sensor, a smart device, or a home controller disposed in the first home 130 and may generate (Block 818), using the AI model, at least one predicted data value for the identified at least one data field further based upon the sensor data.

In some such embodiments, analytics computing device 150 may identify (Block 820) at least one inaccurate data value from the extracted home data based upon the received sensor data and may generate (Block 822), using the AI model, an updated data value to replace the inaccurate data value based upon the sensor data.

In certain embodiments, analytics computing device 150 may receive (Block 824) external data relating to the first home from an external data source and may generate (Block 826), using the AI model, at least one predicted data value for the identified at least one data field further based upon the external data.

In some embodiments, analytics computing device 150 may identify (Block 828), using the AI model, at least one geographic trend associated with a geographic area of the first home and may generate (Block 830), using the AI model, the at least one predicted data value further based upon the identified geographic trend.

In the exemplary embodiment, analytics computing device 150 may store (Block 832) the at least one predicted data value in the identified at least one data field.

In certain embodiments, analytics computing device 150 may cause (Block 834) user device 140 associated with the first home 130 to display at least some of the home data associated with the first home 130 including the at least one predicted data value.

In some embodiments, analytics computing device 150 may generate (Block 836), using the AI model, at least one recommended task based upon the extracted home data, wherein the recommended task includes a repair task to be performed on an item associated with the first home.

In some such embodiments, analytics computing device 150 may generate (Block 838), using the AI model, the at least one recommended task further based upon the at least one predicted value.

In certain such embodiments, analytics computing device 150 may cause (Block 840) user device 140 associated with the first home 130 to display the at least one recommended task.

In some such embodiments, analytics computing device 150 may determine (Block 842), using the AI model, a priority for each of the plurality of recommended tasks and may cause (Block 844) the user device to display the plurality of recommended tasks in an order based upon the determined priority.

In certain such embodiments, analytics computing device 150 may generate (Block 846), using the AI model, digital instructional content based upon the at least one recommended task and may cause (Block 848) user device 140 to present the generated digital instructional content so that a user is able to perform the repair task on the item associated with the first home.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, analytics computing device 150 is configured to implement machine learning, such that analytics computing device 150 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of home attributes with known characteristics or features. Such information may include, for example, information associated with a plurality of IoT devices 110.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative AI models (also referred to as generative machine learning models) may be utilized with the present embodiments and may the voice bots or chatbots discussed herein may be configured to utilize AI and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Exemplary Embodiments

In one exemplary embodiment, a computer system for utilizing artificial intelligence tools to extract and augment data from a home inspection report and generate home recommendations may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer system may be programmed to: (1) receive a first home inspection report associated with a first home; (2) extract, using an artificial intelligence model, home data from the first home inspection report, the artificial intelligence model including extraction tools and trained using correlations between historical home inspection reports and historical home data; (3) store the extracted home data for the first home in a data structure including a plurality of data fields; (4) identify at least one data field of the plurality of data fields that is missing a data value; (5) generate, using the artificial intelligence model, at least one predicted data value for the identified at least one data field based upon the historical home data; and (6) store the at least one predicted data value in the identified at least one data field. The computer system may include additional, less, or alternate functionality, including that discussed elsewhere herein.

In another exemplary embodiment, a computing device for utilizing artificial intelligence tools to extract and augment data from a home inspection report and generate home recommendations may be provided. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computing device may include at least one processor programmed to: (1) receive a first home inspection report associated with a first home; (2) extract, using an artificial intelligence model, home data from the first home inspection report, the artificial intelligence model including extraction tools and trained using correlations between historical home inspection reports and historical home data; (3) store the extracted home data for the first home in a data structure including a plurality of data fields; (4) identify at least one data field of the plurality of data fields that is missing a data value; (5) generate, using the artificial intelligence model, at least one predicted data value for the identified at least one data field based upon the historical home data; and/or (6) store the at least one predicted data value in the identified at least one data field. The computer system may include additional, less, or alternate functionality, including that discussed elsewhere herein.

In yet another exemplary embodiment, a computer-implemented method for utilizing artificial intelligence tools to extract and augment data from a home inspection report and generate home recommendations may be provided. The computer-implemented method may be performed by a computing device including at least one processor and at least one memory device. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. The method may include, via the at least one processor: (1) receiving a first home inspection report associated with a first home; (2) extracting, using an artificial intelligence model, home data from the first home inspection report, the artificial intelligence model including extraction tools and trained using correlations between historical home inspection reports and historical home data; (3) storing the extracted home data in a data structure including a plurality of data fields; (4) identifying at least one data field of the plurality of data fields that is missing a data value; (5) generating, using the artificial intelligence model, at least one predicted data value for the identified at least one data field based upon the historical home data; and/or (6) storing the at least one predicted data value in the identified at least one data field. The method may have additional, less, or alternate actions, including that discussed elsewhere herein.

In still another exemplary embodiment, at least one non-transitory computer-readable media having computer-executable instructions embodied thereon for utilizing artificial intelligence tools to extract and augment data from a home inspection report and generate home recommendations is provided. The computer-executable instructions may be executed by a computing device including one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. When executed by at least one processor, the computer-executable instructions cause the at least one processor to: (1) receive a first home inspection report associated with a first home; (2) extract, using an artificial intelligence model, home data from the first home inspection report, the artificial intelligence model including extraction tools and trained using correlations between historical home inspection reports and historical home data; (3) store the extracted home data for the first home in a data structure including a plurality of data fields; (4) identify at least one data field of the plurality of data fields that is missing a data value; (5) generate, using the artificial intelligence model, at least one predicted data value for the identified at least one data field based upon the historical home data; and/or (6) store the at least one predicted data value in the identified at least one data field. The computer-readable media may have instructions that direct additional, less, or alternate functionality, including that discussed elsewhere herein.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS′ include, but are not limited to including, Oracle® Database, MySQL, IBM® DB2, NoSQL, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device utilizing artificial intelligence tools to extract and augment data from a home inspection report and generate home recommendations, the computing device comprising at least one processor and at least one memory device in communication with the at least one processor, the at least one processor configured to:
receive a first home inspection report associated with a first home;
extract, using an artificial intelligence model, home data from the first home inspection report, the artificial intelligence model including extraction tools and trained using correlations between historical home inspection reports and historical home data;
store the extracted home data for the first home in a data structure including a plurality of data fields;
identify at least one data field of the plurality of data fields that is missing a data value;
generate, using the artificial intelligence model, at least one predicted data value for the identified at least one data field based upon the historical home data; and
store the at least one predicted data value in the identified at least one data field.

2. The computing device of claim 1, wherein the at least one processor is further configured to cause a user device associated with the first home to display at least some of the home data associated with the first home including the at least one predicted data value.

3. The computing device of claim 1, wherein the at least one processor is further configured to generate, using the artificial intelligence model, at least one recommended task based upon the extracted home data, wherein the recommended task includes a repair task to be performed on an item associated with the first home.

4. The computing device of claim 3, wherein the at least one processor is further configured to cause a user device associated with the first home to display the at least one recommended task.

5. The computing device of claim 4, wherein the at least one recommended task includes a plurality of recommended tasks, and wherein the at least one processor is further configured to:
determine, using the artificial intelligence model, a priority for each of the plurality of recommended tasks; and
cause the user device to display the plurality of recommended tasks in an order based upon the determined priority.

6. The computing device of claim 4, wherein the at least one processor is further configured to:
generate, using the artificial intelligence model, digital instructional content based upon the at least one recommended task; and
cause the user device to present the generated digital instructional content so that a user is able to perform the repair task on the item associated with the first home.

7. The computing device of claim 3, wherein the at least one processor is further configured to generate, using the artificial intelligence model, the at least one recommended task further based upon the at least one predicted value.

8. The computing device of claim 1, wherein the at least one processor is further configured to:
receive sensor data from one or more of a sensor, a smart device, or a home controller disposed in the first home; and
generate, using the artificial intelligence model, at least one predicted data value for the identified at least one data field further based upon the sensor data.

9. The computing device of claim 8, wherein the at least one processor is further configured to:
identify at least one inaccurate data value from the extracted home data based upon the received sensor data; and
generate, using the artificial intelligence model, an updated data value to replace the inaccurate data value based upon the sensor data.

10. The computing device of claim 1, wherein the at least one processor is further configured to:
receive external data relating to the first home from an external data source; and
generate, using the artificial intelligence model, at least one predicted data value for the identified at least one data field further based upon the external data.

11. The computing device of claim 1, wherein the at least one processor is further configured to:
identify, using the artificial intelligence model, at least one geographic trend associated with a geographic area of the first home; and
generate, using the artificial intelligence model, the at least one predicted data value further based upon the identified geographic trend.

12. The computing device of claim 1, wherein the at least one processor is further configured to:
cause a user device associated with the first home to display a prompt to at least one of upload or capture an image of the first home inspection report; and
receive data representing the first home inspection report from the user device.

13. A computer-implemented method computing device for utilizing artificial intelligence tools to extract and augment data from a home inspection report and generate home recommendations, the computer-implemented method performed by a computing device including at least one processor and at least one memory device in communication with the at least one processor, the computer-implemented method comprising:
receiving, by the at least one processor, a first home inspection report associated with a first home;
extracting, by the at least one processor, using an artificial intelligence model, home data from the first home inspection report, the artificial intelligence model including extraction tools and trained using correlations between historical home inspection reports and historical home data;
storing, by the at least one processor, the extracted home data in a data structure including a plurality of data fields;
identifying, by the at least one processor, at least one data field of the plurality of data fields that is missing a data value;
generating, by the at least one processor, using the artificial intelligence model, at least one predicted data value for the identified at least one data field based upon the historical home data; and
storing, by the at least one processor, the at least one predicted data value in the identified at least one data field.

14. The computer-implemented method of claim 13, further comprising causing, by the at least one processor, a user device associated with the first home to display at least some of the home data associated with the first home including the at least one predicted data value.

15. The computer-implemented method of claim 13, further comprising generating, by the at least one processor, using the artificial intelligence model, at least one recommended task based upon the extracted home data, wherein the recommended task includes a repair task to be performed on an item associated with the first home.

16. The computer-implemented method of claim 15, further comprising causing, by the at least one processor, a user device associated with the first home to display the at least one recommended task.

17. The computer-implemented method of claim 16, wherein the at least one recommended task includes a plurality of recommended tasks, and wherein the computer-implemented method further comprises:
determining, by the at least one processor, using the artificial intelligence model, a priority for each of the plurality of recommended tasks; and
causing, by the at least one processor, the user device to display the plurality of recommended tasks in an order based upon the determined priority.

18. The computer-implemented method of claim 16, further comprising:
generating, by the at least one processor, using the artificial intelligence model, digital instructional content based upon the at least one recommended task; and
causing, by the at least one processor, the user device to present the generated digital instructional content so that a user is able to perform the repair task on the item associated with the first home.

19. The computer-implemented method of claim 15, further comprising generating, by the at least one processor, using the artificial intelligence model, the at least one recommended task further based upon the at least one predicted value.

20. At least one non-transitory computer-readable media having computer-executable instructions embodied thereon for utilizing artificial intelligence tools to extract and augment data from a home inspection report and generate home recommendations, wherein when executed by a computing device including at least one processor and at least one memory device in communication with the at least one processor, the computer-executable instructions cause the at least one processor to:
receive a first home inspection report associated with a first home;
extract, using an artificial intelligence model, home data from the first home inspection report, the artificial intelligence model including extraction tools and trained using correlations between historical home inspection reports and historical home data;
store the extracted home data for the first home in a data structure including a plurality of data fields;
identify at least one data field of the plurality of data fields that is missing a data value;
generate, using the artificial intelligence model, at least one predicted data value for the identified at least one data field based upon the historical home data; and
store the at least one predicted data value in the identified at least one data field.
